(19) United States
(12) Patent Application Publication
(10) Pub. No.: US 2024/0122240 A1
(43) Pub. Date: Apr. 18, 2024

(54) Vaporization Devices That Include a Light Source

(71) Applicant: Slap N Tickle Ltd., Toledo, OH (US)

(72) Inventor: Brian Nupp, Maumee, OH (US)

(73) Assignee: Slap N Tickle Ltd., Toledo, OH (US)

(21) Appl. No.: 18/241,292

(22) Filed: Sep. 1, 2023

Related U.S. Application Data
(60) Provisional application No. 63/447,920, filed on Feb. 24, 2023.
(60) Provisional application No. 63/426,517, filed on Nov. 18, 2022.
(60) Provisional application No. 63/416,012, filed on Oct. 14, 2022.

(51) Int. Cl. A24F 40/40; A24F 47/00

(52) U.S. Cl. CPC A24F 40/40; A24F 47/00; F21V 33/0004

(57) ABSTRACT

Vaporization devices that include a light source are described. An example vaporization device includes a housing, a power source, a tip, a switch, and a light source. The housing has a first end and a second end. The power source is disposed within the housing. The tip is disposed on the housing and has a heating element connected to the power source and configured to heat a consumable product. The heating element is moveable between an on state and off state. The switch is attached to the housing and moves the heating element between the on state and the off state upon selective activation of the switch. The light source is disposed on the housing and is moveable between an on state and an off state. The light source emits direct light away from the first end of the housing when the light source is in the on state.

### CROSS REFERENCE TO RELATED APPLICATIONS

This application claims the benefit of U.S. Provisional Application No. 63/416,012, filed Oct. 14, 2022, U.S. Provisional Application No. 63/426,517, filed Nov. 18, 2022, and U.S. Provisional Application No. 63/447,920, filed Feb. 24, 2023. The entire contents of each of these related applications are hereby incorporated by reference into this disclosure.

### FIELD

The disclosure relates generally to the field of smoking products. More particularly, the disclosure relates to vaporization devices, such as nectar collectors, that include a light source.

### BACKGROUND

Generally, vaporization devices and nectar collectors heat a consumable product (e.g., oil, wax, concentrate, combustible plant substance) to create a vapor for a user to inhale. With respect to nectar collectors, a tip of vaporization device is pre-heated and then dipped into the consumable product. A vapor is created from heating the consumable product, which can then be inhaled by the user. Typically, the vapors of the consumable product are created as soon as the pre-heated tip contacts the consumable product. However, depending on the setting, it may be difficult to determine whether or not the tip is near, or is contacting, the consumable product during use. This is particularly true in dark settings. As a result, a user may fail to contact the tip with the consumable product resulting in no vapors being produced for inhalation. Alternatively, a user may contact the tip with the consumable product for an extended period of time, which can burn the consumable product and impact the taste or effect of the vapor on the user. Furthermore, failure to use heating elements as directed may result in corrosion or other defects, which can reduce the useful life of the heating element.

Therefore, a need exists for new and useful vaporization devices that include a light source.

### SUMMARY OF SELECTED EXAMPLE EMBODIMENTS

Various vaporization devices that include a light source are described herein.

An example vaporization device includes a housing, a power source, a tip, a switch, and a light source. The housing has a first end and a second end. The power source is disposed within the housing. The tip is disposed on the housing and has a heating element connected to the power source and configured to heat a consumable product. The heating element is moveable between an on state and off state. The switch is attached to the housing and moves the heating element between the on state and the off state upon selective activation of the switch. The light source is disposed on the housing and is moveable between an on state and an off state. The light source emits direct light away from the first end of the housing when the light source is in the on state.

Another example vaporization device includes a housing, a power source, a tip, a first switch, a light source, and a second switch. The housing has a first end, a second end, and defines a passageway. The power source is disposed within the housing. The tip is disposed on the housing and has a heating element connected to the power source and configured to heat said consumable product to create a vapor. The heating element moveable between an on state and an off state. The first switch attached to the housing and moving the heating element between the on state and the off state upon selective activation of the switch. The light source is disposed within the housing and is moveable between an on state and an off state. The light source emits direct light through the passageway of the housing and away from the first end of the housing when the light source is in the on state. The second switch is attached to the housing and moves the light source between the on state and the off state upon selective activation of the second switch.

Another example vaporization device includes a housing, a tip, a first switch, a light source, a second switch, and a cap. The housing has a first end, a second end, and defines a passageway. The power source is disposed within the housing. The tip is disposed on the housing and has a heating element connected to the power source and configured to heat said consumable product to create a vapor. The heating element is moveable between an on state and an off state. The first switch is attached to the housing and moves the heating element between the on state and the off state upon selective activation of the switch. The light source is disposed within the housing, is connected to the power source, and is moveable between an on state and an off state. The light source emits direct light through the passageway of the housing and away from the first end of the housing when the light source is in the on state. The second switch is attached to the housing and moves the light source between the on state and the off state upon selective activation of the second switch. The cap is disposed on the second end of the housing and has a first portion releasably attached to the housing and a second portion releasably attached to the first portion. The first portion is formed of a first material and the second portion formed of a second material that is different than the first material.

Additional understanding of these example vaporization devices can be obtained by review of the detailed description, below, and the appended drawings.

### BRIEF DESCRIPTION OF THE DRAWINGS

FIG. 1 is a perspective view of a first example vaporization device. The first cap is releasably attached to the housing and is in a first, assembled configuration. The light source is in an off state.

FIG. 2 is a partially exploded perspective view of the vaporization device shown in FIG. 1. The first cap is free of attachment to the housing and is in a second, disassembled configuration. The light source is in an off state.

FIG. 3 is a partial cross-sectional view of the vaporization device shown in FIG. 1 taken along the lengthwise axis of the housing.

FIG. 4 is a partial perspective view of the vaporization device shown in FIG. 1 being used. The first cap is free of attachment to the housing and is in a second, disassembled configuration. The light source is in an off state.

FIG. 5 is a perspective view of a second example vaporization device. The first cap is free of attachment to the housing and is in a second, disassembled configuration. The light source is in an off state. The second cap is in a second configuration and not disposed over the first end of the elongate tubular member.

FIG. 6 is a partial perspective view of the vaporization device shown in FIG. 5. The light source is in an on state.

FIG. 7 is a perspective view of a third example vaporization device. The first cap is free of attachment to the housing and is in a second, disassembled configuration. The light source is in an on state. The second cap is in a second configuration and not disposed over the first end of the elongate tubular member.

FIG. 8 is a perspective view of a fourth example vaporization device. The first cap is releasably attached to the housing and is in a first, assembled configuration. The light source is in an off state. The second cap is in a first configuration and is disposed over the first end of the mouthpiece.

FIG. 9 is another perspective view of the vaporization device shown in FIG. 8.

FIG. 10 is a partially exploded front view of the vaporization device shown in FIG. 8. The first cap is free of attachment to the housing and is in a first, assembled configuration. The light source is in an off state. The second cap is in a first configuration and is disposed over the first end of the mouthpiece.

FIG. 11 is a sectional view of the vaporization device shown in FIG. 8.

FIG. 12 is a magnified view of area A-A shown in FIG. 11.

FIG. 13 is another sectional view of the vaporization device shown in FIG. 8 and illustrates airflow during use.

FIG. 14 is a magnified view of area B-B shown in FIG. 13.

FIG. 15 is an exploded view of the vaporization device shown in FIG. 8.

FIG. 16 is a perspective view of the top wall of the housing of the vaporization device shown in FIG. 8.

FIG. 17 is another perspective view of the top wall shown in FIG. 16.

FIG. 18 is a sectional view of the top wall shown in FIG. 16.

FIG. 19 is a perspective view of the second sealing member of the housing of the vaporization device shown in FIG. 8.

FIG. 20 is a sectional view of the second sealing member shown in FIG. 19.

FIG. 21 is a perspective view of the base of the tip of the vaporization device shown in FIG. 8.

FIG. 22 is a sectional view of the base shown in FIG. 21.

FIG. 23 is a perspective view of the heating element of the tip of the vaporization device shown in FIG. 8.

FIG. 24 is a sectional view of the tip shown in FIG. 23.

FIG. 25 is a perspective view of the threaded member of the tip of the vaporization device shown in FIG. 8.

FIG. 26 is a sectional view of the threaded member shown in FIG. 25.

FIG. 27 is a perspective view of the insulating ring of the tip of the vaporization device shown in FIG. 8.

FIG. 28 is a sectional view of the insulating ring shown in FIG. 27.

FIG. 29 is a perspective view of the electrode of the tip of the vaporization device shown in FIG. 8.

FIG. 30 is a sectional view of the electrode shown in FIG. 29.

FIG. 31 is a perspective view of an alternative heating element of a tip of a vaporization device.

FIG. 32 is a sectional view of the tip shown in FIG. 31.

FIG. 33 is a perspective view of a fifth example vaporization device. The first cap is releasably attached to the housing and is in a first, assembled configuration. The light source is in an off state. The second cap is in a first configuration and is disposed over the first end of the mouthpiece.

FIG. 34 is another perspective view of the vaporization device shown in FIG. 33.

FIG. 35 is another perspective view of the vaporization device shown in FIG. 33. The first cap is free of attachment to the housing.

FIG. 36 is another perspective view of the vaporization device shown in FIG. 33. The first cap is free of attachment to the housing.

FIG. 37 is a left side view of the vaporization device shown in FIG. 33.

FIG. 38 is a front view of the vaporization device shown in FIG. 33.

FIG. 39 is a right side view of the vaporization device shown in FIG. 33.

FIG. 40 is a rear view of the vaporization device shown in FIG. 33.

FIG. 41 is a left side view of the vaporization device shown in FIG. 33. The first cap is free of attachment to the housing.

FIG. 42 is a front view of the vaporization device shown in FIG. 33. The first cap is free of attachment to the housing.

FIG. 43 is a right side view of the vaporization device shown in FIG. 33. The first cap is free of attachment to the housing.

FIG. 44 is a rear view of the vaporization device shown in FIG. 33. The first cap is free of attachment to the housing.

FIG. 45 is a top view of the vaporization device shown in FIG. 33.

FIG. 46 is a bottom view of the vaporization device shown in FIG. 33.

FIG. 47 is a partial perspective view of the vaporization device shown in FIG. 33. The first cap is free of attachment to the housing.

FIG. 48 is a bottom view of the vaporization device shown in FIG. 33. The first cap is free of attachment to the housing.

FIG. 49 is a sectional view of the vaporization device shown in FIG. 33.

FIG. 50 is a partial sectional view of the vaporization device shown in FIG. 33.

FIG. 51 is another sectional view of the vaporization device shown in FIG. 33.

FIG. 52 is another partial sectional view of the vaporization device shown in FIG. 33.

FIG. 53 is an exploded view of the vaporization device shown in FIG. 33.

FIG. 54 is a perspective view of a portion of the vaporization device shown in FIG. 33.

FIG. 55 is another perspective view of the portion of the vaporization device shown in FIG. 54.

FIG. 56 is a perspective view of the bracket of the vaporization device shown in FIG. 33.

FIG. 57 is another perspective view of the bracket shown in FIG. 56.

FIG. 58 is another perspective view of the bracket shown in FIG. 56.

FIG. 59 is a bottom view of the bracket shown in FIG. 56.

FIG. 60 is a top view of the bracket shown in FIG. 56.

FIG. 61 is a perspective view of the first sealing member of the housing of the vaporization device shown in FIG. 33.

FIG. 62 is another perspective view of the first sealing member shown in FIG. 61.

FIG. 63 is a perspective view of the top wall of the first portion of the housing of the first cap of the vaporization device shown in FIG. 33.

FIG. 64 is another perspective view of the top wall shown in FIG. 63.

FIG. 65 is a perspective view of the base of the tip of the vaporization device shown in FIG. 33.

FIG. 66 is another perspective view of the base shown in FIG. 65.

FIG. 67 is a perspective view of the second sealing member of the vaporization device show in in FIG. 33.

FIG. 68 is a top view of the second sealing member shown in FIG. 67.

FIG. 69 is a sectional view of the second sealing member shown in FIG. 67.

### DETAILED DESCRIPTION

The following detailed description and the appended drawings describe and illustrate various example embodiments of vaporization devices. The description and illustration of these examples are provided to enable one skilled in the art to make and use a vaporization device. They are not intended to limit the scope of the claims in any manner.

As used herein, “light source” means any device, component, piece of equipment, or mechanism that is a source of illumination perceptible to the human eye.

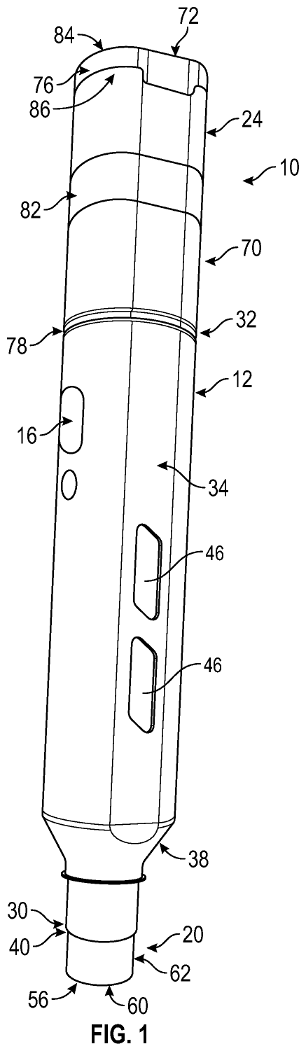

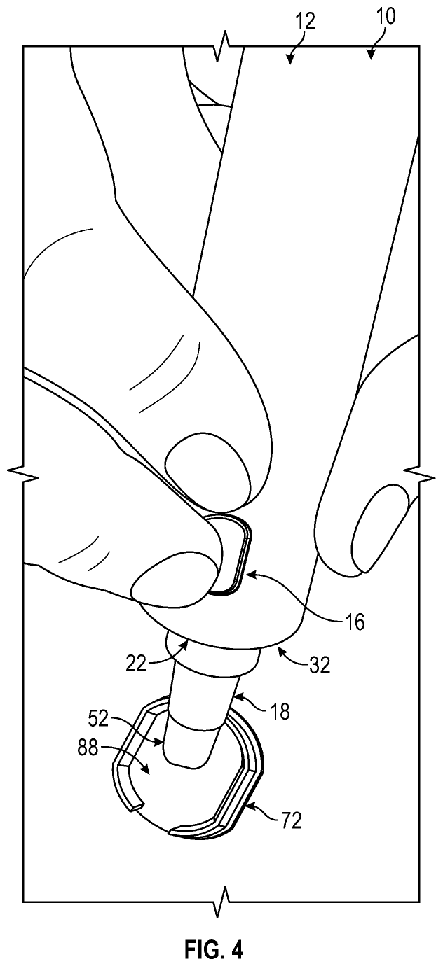

FIGS. 1, 2, 3, and 4 illustrate a first example vaporization device 10. The vaporization device 10 has a housing 12, a power source 14, a switch 16, a tip 18, an elongate tubular member 20, a light source 22, and a first cap 24.

The housing 12 has a lengthwise axis 29, a first end 30, a second end 32, a sidewall 34, a bottom wall 36, a top wall 38, and defines a first opening 40 at the first end 30, a second opening 42 at the second end 32, a chamber 44, a plurality of windows 46, and a passageway 48. As shown in FIG. 3, the bottom wall 36 is disposed at an angle 37 relative to the sidewall 34. The angle 37 can be any suitable angle and selection of a suitable angle can be based on various considerations, such as the amount of direct light (e.g., light that strikes an area or object directly from a light source) desired to contact a tip and/or object of interest during use. Examples of angles considered suitable to position a bottom wall relative to a sidewall include angles between about 181 degrees and about 359 degrees, angles between about 245 degrees and about 295 degrees, angles about 270 degrees, and any other angle considered suitable for a particular embodiment. In the illustrated embodiment, the angle 37 is about 270 degrees.

The first opening 40 is sized and configured to receive a portion of the elongate tubular member 20, as described in more detail herein. The second opening 42 is sized and configured to receive a portion of the tip 18, the elongate tubular member 20, and/or a portion of a power source (e.g., wire members 43) to accomplish an electrical connection between the power source 14 and the tip 18. In the illustrated embodiment, the chamber 44 extends from the first opening 40 to the second opening 42. Each window of the plurality of windows 46 provides access to the chamber 44 and allows for visualization of the elongate tubular member 20 during use. For example, each window of the plurality of windows 46 provides a mechanism for determining if the elongate tubular member 20 requires cleaning. In the illustrated embodiment, a material (e.g., glass, plastic) is disposed over each window of the plurality of windows 46 to prevent contaminants from entering the chamber 44. However, alternative embodiments can omit such material.

The passageway 48 is defined on the bottom wall 36, has a center 45, has a lengthwise axis 47, and is in fluid communication with the chamber 44 (e.g., extends from the chamber 44 to an environment exterior 49 to the chamber 44). The lengthwise axis 47 of the passageway 48 extends through the passageway 48, through the center 45 of the passageway 48, and is directed toward the lengthwise axis 29 of the housing 12. In the illustrated embodiment, the lengthwise axis 47 of the passageway 48 extends through the passageway 48, through the center 45 of the passageway 48, and is directed toward the tip 18 such that the lengthwise axis 47 of the passageway 48 intersects the tip 18, as shown in FIG. 3. In alternative embodiments, however, a passageway can be oriented in any suitable manner. For example, a lengthwise axis of a passageway can extend through the passageway, through a center of the passageway, intersect a tip, not intersect a tip, extend parallel to, or away from, a lengthwise axis of a housing, be directed toward a lengthwise axis of a housing, be directed distal to a tip (e.g., between about 0.1 inches and about 12 inches distal to a tip along a lengthwise axis of a housing, between about 1 inch and about 3 inches distal to a tip along a lengthwise axis of a housing, about 1 inch distal to a tip along a lengthwise axis of a housing), and/or be positioned in any other orientation considered suitable for a particular embodiment.

While the housing 12 has been illustrated as having a particular structural arrangement, a housing can have any suitable structural arrangement, be formed of any suitable material, and be manufactured using any suitable technique or method. Selection of a suitable structural arrangement for a housing, material to form a housing, and of a suitable technique or method of manufacture for a housing can be based on various considerations, such as the type and number of components housed within a housing. For example, a housing can omit the inclusion of a plurality of windows, or include more than two windows positioned at any suitable location along a length of a housing. Examples of materials considered suitable to form a housing include plastics, metals, aluminum alloys, and any other material considered suitable for a particular embodiment. In the illustrated embodiment, the housing 12 is formed of a metal.

As shown in FIG. 3, the power source 14 is disposed on the housing 12 and is electrically connected to the switch 16 (e.g., using wire members 43), the heating element 52 of the tip 18 (e.g., using wire members 43), and the light source 22 (e.g., using wire members 43). In the illustrated embodiment, the power source 14 is disposed within the chamber 44. The power source 14 can comprise any suitable power source capable of powering the light source 22 and/or the heating element 52 of the tip 16 such that the heating element 52 reaches a temperature that heats a consumable product (e.g., oil, wax, concentrate, combustible plant substance) such that it create a vapor for a user to inhale. Examples of power sources considered suitable to include in a vaporization device include, but are not limited to, batteries, batteries that are activated automatically upon inhalation by a user, manual batteries that are activated by a switch, variable voltage batteries, variable wattage batteries, nickel-cadmium batteries, lithium batteries, lithium-polymer batteries, and any other power source considered suitable for a particular embodiment. While only one power source has been illustrated, more than one (e.g., a plurality, two, three, more than three) power sources can be included in a vaporization device. For example, a vaporization device can include a first power source and a second power source. The second power source can be exclusively for use by the light source, or any other component, as described herein.

The switch 16 is disposed on the housing 12 and is electrically connected to the power source 14, the tip 18 (e.g., heating element 52), and the light source 22. In the embodiment shown, the switch 16 is attached to the housing 12 and is accessible by a user. The switch 16 has a first configuration and a second configuration and can be selectively activated by a user. The heating element 52 is in the off state and the light source 22 is in the off state when the switch is in the first configuration. The heating element 52 is in the on state and the light source 22 is in the on state when the switch is in the second configuration. Any suitable switch can be included in a vaporization device and selection of a suitable switch can be based on various considerations, such as the type of heating element and/or light source included in a vaporization device. Examples of switches considered suitable to include in a vaporization device include push-button switches, toggle switches, slide switches, rotary switches, switches that are draw-activated (e.g., turn components on when a user inhales on an elongate tubular member, turn components off when a user is not inhaling on an elongate tubular member), and any other switch considered suitable for a particular embodiment. In the illustrated embodiment, the switch 16 comprises a push-button switch 50.

The tip 18 is disposed on the second end 32 of the housing 12, includes a heating element 52, and defines a passageway 54. The tip 18 is electrically connected to the power source 14 and is configured to heat a consumable product (e.g., oil, wax, concentrate, combustible plant substance) using the heating element 52 to create a vapor for a user to inhale. The heating element 52 is electrically connected to the power source 14 and the switch 16 and can be activated by the power source 14 upon selective activation of the switch 16 by a user. The heating element 52 is moveable between an on state and an off state by the power source 14 upon selective activation of the switch 16. The passageway 54 extends through the tip 18 and is in fluid communication with the passageway 60 defined by the elongate tubular member 20, as described in more detail herein. A tip can be formed of any suitable material and selection of a suitable material to form a tip can be based on various considerations, such as the material intended to be heated by the tip. Examples of materials considered suitable to form a tip include glass, ceramic, titanium, quartz, and any other material considered suitable for a particular embodiment. In the illustrated embodiment, the tip 18 is formed of titanium.

The elongate tubular member 20 has a first end 56, a second end 58, and defines a passageway 60 and a mouthpiece 62 at the first end 56. The second end 58 of the elongate tubular member 20 is attached to the tip 18 (e.g., directly or indirectly) such that the passageway 60 of the elongate tubular member 20 and the passageway 54 of the tip 18 are in fluid communication with one another. The elongate tubular member 20 extends from the tip 18 toward the first end 30 of the housing 12. In the illustrated embodiment, the elongate tubular member 20 is partially disposed within the chamber 44 of the housing 12, the first end 56 is disposed proximal to the first end 30 of the housing 12 (e.g., outside of the chamber 44 of the housing 12), and the first end 56 comprises the mouthpiece 62. However, in alternative embodiments, additional structure and/or components can be included on a first end of an elongate tubular member to define a mouthpiece.

An elongate tubular member can have any suitable structural arrangement and be formed of any suitable material and selection of a suitable structural arrangement and material to form an elongate tubular member can be based on various considerations, such as the intended use of a vaporization device of which the elongate tubular member is a component. For example, in some embodiments an elongate tubular member can include a bubbler. Examples of materials considered suitable to form an elongate tubular member include glass, metal, ceramic, and any other material considered suitable for a particular embodiment. In the illustrated embodiment, the elongate tubular member 20 is formed of glass. Optionally, an elongate tubular member can be omitted from a vaporization device and other structure (e.g., housing) can define a lumen that fluidly connects to a heating element or that fluidly connects a heating element to a mouthpiece.

The light source 22 has a lengthwise axis 63, a center 65, is disposed on (e.g., attached to) the housing 12, and is moveable between an on state and an off state. The light source 22 is disposed between the first end 30 and the second end 32 of the housing 12 and is electrically connected to the power source 14 and the switch 16. The light source 22 can be moved between the off state and the on state by the power source 14 upon selective activation of the switch 16 by a user. When activated, the light source 22 emits direct light away from the first end 30 of the housing 12. In the illustrated embodiment, when activated, the light source 22 emits light towards the tip 18 and direct light strikes the tip 18. In the embodiment shown, when a user selectively activates the switch 16, both the heating element 52 and the light source 22 are activated. However, in alternative embodiments, more than one switch can be included on a vaporization device such that a first switch independently controls a heating element of the vaporization device and a second switch independently control a light source of the vaporization device.

The light source 22 is disposed on the housing 12 such that the light source 22 emits light through the passageway 48 of the housing 12 and direct light strikes the tip 18. The light source 22 is disposed on the bottom wall 36 of the housing 12 and within the passageway 48 of the housing 12 such that the lengthwise axis 63 of the light source 22 extends through the center 65 of the light source 22, through passageway 48 of the housing 12, and is directed away from the first end 30 of the housing 12 and toward the lengthwise axis of the housing 12. In the illustrated embodiment, the light source 22 is disposed on the bottom wall 36 of the housing 12 and within the passageway 48 of the housing 12 such that the lengthwise axis 63 of the light source 22 extends through the center 65 of the light source 22, through passageway 48 of the housing 12, and is directed toward the tip 18 such that the lengthwise axis 63 of the light source 22 intersects the tip 18, as shown in FIG. 3. In alternative embodiments, however, a light source can be positioned on any suitable portion of a housing and/or oriented in any suitable manner such that direct light from the light source strikes a tip, is directed away from a first end of a housing, and/or strikes a location distal to a tip (e.g., between about 0.1 inches and about 12 inches distal to a tip along a lengthwise axis of a housing, between about 1 inch and about 3 inches distal to a tip along a lengthwise axis of a housing, about 1 inch distal to a tip along a lengthwise axis of a housing). For example, a lengthwise axis of a light source can extend through a center of the light source, through a passageway, intersect a tip, not intersect a tip, extend parallel to, or away from, a lengthwise axis of a housing, be directed toward a lengthwise axis of a housing, be directed distal to a tip (e.g., between about 0.1 inches and about 12 inches distal to a tip along a lengthwise axis of a housing, between about 1 inch and about 3 inches distal to a tip along a lengthwise axis of a housing, about 1 inch distal to a tip along a lengthwise axis of a housing), and/or be positioned in any other orientation considered suitable for a particular embodiment.

As described herein, the housing 12 and the light source 22 have a specific relative structural arrangement to accomplish direct light striking the tip 18, being directed away from the first end 30 of the housing 12, and/or striking a location distal to the tip 18. In the illustrated embodiment, the lengthwise axis 47 of the passageway 48 and the lengthwise axis 63 of the light source 22 are coaxial and directed toward the tip 18 such that they intersect the tip 18. In alternative embodiments, however, a lengthwise axis of a light source and a lengthwise axis of a passageway can be oriented in any suitable manner. For example, a lengthwise axis of a light source (e.g., an axis extending through the light source) and a lengthwise axis of a passageway can be non-coaxial, oriented such that they are both directed toward a lengthwise axis of a housing, oriented such that they are both directed toward and intersect a tip, oriented such that they are both directed away from a first end of a housing, oriented such that one axis is directed toward a tip and intersects the tip and another axis is directed to a location distal to a tip, oriented such that both axes are directed to a location distal to a tip, oriented such that one axis is directed away from a first end of a housing and another axis is directed to a location distal to a tip, oriented such that one axis is directed toward a tip and intersects the tip and another axis directed away from a first end of a housing, and any other orientation considered suitable for a particular embodiment. Optionally, a lens can be included on a housing and disposed between a light source and a tip such that the light emitted from the light source can be focused on the tip, away from a first end of a housing, and/or on a location distal to the tip. Depending on the arrangement and type of components used in a vaporization device, a switch and a heating element can be configured such that the heating element remains in the on state until it reaches a temperature capable of heating a consumable product (e.g., oil, wax, concentrate, combustible plant substance) to create vapors. Subsequently, the switch can automatically move the heating element to the off state without user input. In these embodiments, a light source can remain in the on state for a predetermined period of time (e.g., seconds, minutes) subsequent to the heating element moving to the off state, or a light source can be moved to the off state in combination with the heating element.

A light source can be any suitable light source, emit light having any suitable color, and be positioned at any suitable location along a length of a housing and selection of a suitable light source for inclusion in a vaporization device and of a suitable location to position a light source can be based upon various considerations, including the type of light source included in a vaporization device and/or the materials used to form a vaporization device. Examples of light sources considered suitable to include in a vaporization device include light emitted diodes (LEDs), optical fibers with or without cladding, point lights, spot lights, directional lights, light sources that include independent power sources, and any other light source considered suitable for a particular embodiment. In the illustrated embodiment, the light source 22 is an LED. While a single light source 22 has been illustrated as being included on the vaporization device 10, a vaporization device can include any suitable number of light sources and selection of a suitable number of light sources to include in a vaporization device can be based on various considerations, including the shape and/or size of a tip included in a vaporization device. For example, a vaporization device can include one, more than one, two, a plurality, three, four, five, or more than five light sources. In embodiments in which more than one light source is included in a vaporization device, each light source can be positioned on a housing and relative to a tip as described with respect to light source 22. Examples of colors considered suitable for a light source to emit include red, blue, green, white, yellow, and any other color considered suitable for a particular embodiment.

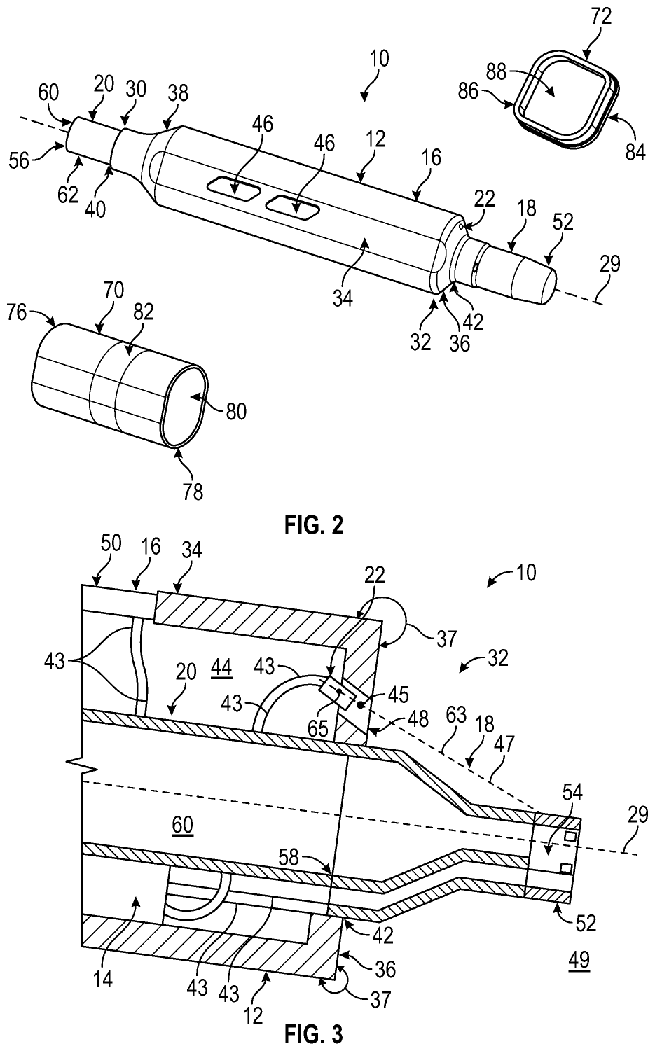

The cap 24 is disposed on the second end 32 of the housing 12 and has a first portion 70 and a second portion 72. The cap 24 can be releasably attached to the housing 12, as shown in FIG. 1, in which the first portion 70 is releasably attached to the housing 12. Alternatively, the cap 24 can be free of attachment to the housing 12, as shown in FIG. 2, in which the first portion 70 is free of attachment to the housing 12 and is capable of releasable attachment to the housing 12. The cap 24 is moveable between a first, assembled configuration and a second, disassembled configuration. In the first, assembled configuration, the second portion 72 is releasably attached to the first portion 70. In the second, disassembled configuration, the second portion 72 is free of attachment to the first portion 70 and is capable of releasable attachment to the first portion 70. The first portion 70 and the second portion 72 can be formed of any suitable material. Examples of materials considered suitable to form a first portion and/or a second portion of a cap include plastics, metals, aluminum alloys, silicone, and any other material considered suitable for a particular embodiment. In the illustrated embodiment, the first portion 70 is formed of a first material and the second portion 72 is formed of a second material. In the illustrated embodiment, the first and second materials are the same.

The first portion 70 has a first end 76, a second end 78, and defines a passageway 80 and a window 82. The passageway 80 extends from the first end 76 to the second end 78. In the illustrated embodiment, the window 82 extends around the entire circumference of the first portion 70 and is formed of a transparent, or semi-transparent, material such that a user can view any contents stored within the first portion 70. However, in alternative embodiments, a window can be omitted from, or partially extend around the circumference of, a first portion. The second portion 72 has a first end 84, a second end 86, and defines a recess 88 that extends from the second end 86 toward the first end 84. When in the first, assembled configuration, the second portion 72 is releasably attached to the second end 78 of the first portion 70.

A vaporization device described herein can include other features, elements, and components and selection of other features, elements, and components can be based on various considerations, such as the consumable product intended to be heated by the vaporization device. Examples of additional features, elements, and/or components considered suitable to include in a vaporization device include a temperature light, additional switches to control components described herein independently, cartridges containing a consumable product, and any other feature, element, and component considered suitable for a particular embodiment.

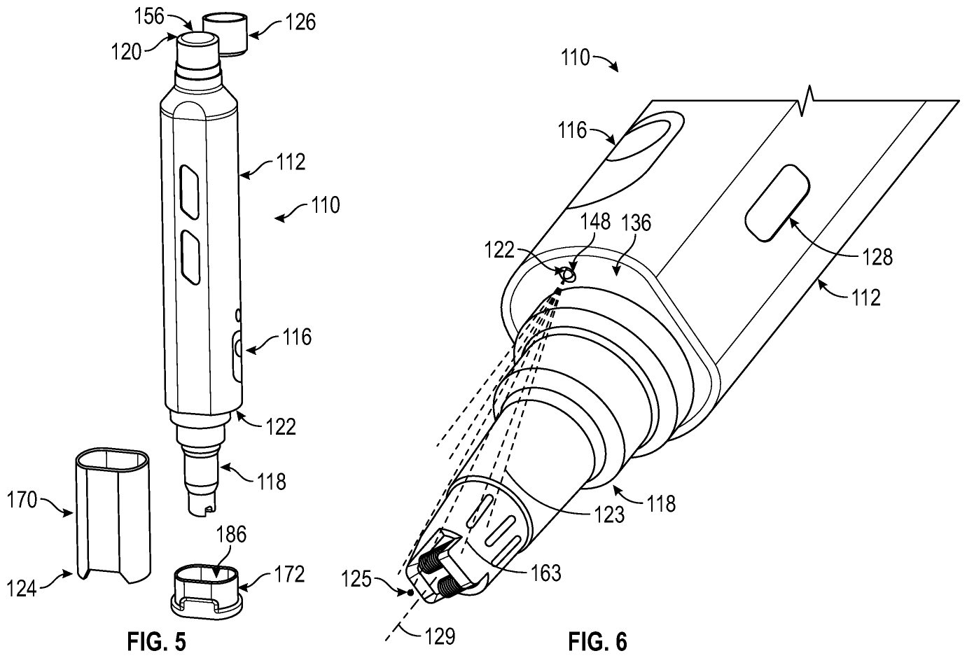

FIGS. 5 and 6 illustrate another example vaporization device 110. The vaporization device 110 is similar to the vaporization device 10 illustrated in FIGS. 1 through 4 described above, except as detailed below. In the illustrated embodiment, the vaporization device 110 has a housing 112, a power source (not shown), a switch 116, a tip 118, an elongate tubular member 120, a light source 122, a first cap 124, a second cap 126, and a charging port 128.

In the illustrated embodiment, the housing 112 is formed of aluminum alloy. As shown in FIG. 6, the light source 122 is disposed on the housing 112 such that when the light source 122 is in the on state it emits light through the passageway 148 of the housing 112 and direct light 123 strikes the tip 118 and strikes a location 125 distal to the tip 118. The light source 122 is disposed on the bottom wall 136 of the housing 112 and within the passageway 148 of the housing 112 such that the lengthwise axis 163 of the light source 122 extends through the light source 122, through passageway 148 of the housing 112, and is directed toward the lengthwise axis 129 of the housing 112. In the illustrated embodiment, the light source 122 is disposed on the bottom wall 136 of the housing 112 and within the passageway 148 of the housing 112 such that the lengthwise axis 163 of the light source 122 extends through the light source 122, through passageway 148 of the housing 112, and is directed toward the tip 118 such that the lengthwise axis 163 of the light source 122 intersects the tip 118.

The first cap 124 has a first portion 170 and a second portion 172. The first portion 170 is formed of a first material and the second portion 172 is formed of a second material. In the illustrated embodiment, the second material is different than the first material. In the illustrated embodiment, the first material is an aluminum alloy and the second material is a ceramic (e.g., the outer body of the second portion is formed of aluminum alloy and the inner portion defining the recess 186 is formed of ceramic).

The second cap 126 is releasably attached to the housing 112 and/or the elongate tubular member 120 and is moveable between a first configuration and a second configuration. In the first configuration, the second cap 126 is disposed over the first end 156 of the elongate tubular member 120. In the second configuration, as shown in FIG. 5, the second cap 126 is not disposed over the first end 156 of the elongate tubular member 120. The second cap 126 can be formed of any suitable material, such as those described herein with respect to the first cap. In the illustrated embodiment, the second cap 126 is formed of silicone. The charging port 128 is electrically connected to the power source and provides a mechanism for charging the power source prior to, or during, use. Optionally, a first cap, a second cap, and/or a charging port can be omitted from a vaporization device.

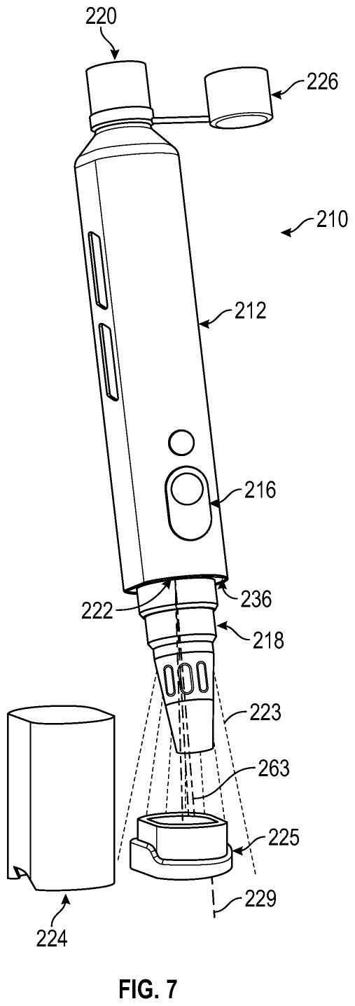

FIG. 7 illustrates another example vaporization device 210. The vaporization device 210 is similar to the vaporization device 110 illustrated in FIGS. 5 and 6 described above, except as detailed below. In the illustrated embodiment, the vaporization device 210 has a housing 212, a power source (not shown), a switch 216, a tip 218, an elongate tubular member 220, a light source 222, a first cap 224, and a second cap 226.

The light source 222 is disposed on the housing 212 such that when the light source 222 is activated it emits light and direct light 223 strikes a location 225 distal to the tip 218. The light source 222 is disposed on the bottom wall 236 of the housing 212 such that the lengthwise axis 263 of the light source 222 extends through the light source 222 and is directed toward the lengthwise axis 229 of the housing 212. In the illustrated embodiment, the light source 222 is disposed on the bottom wall 236 of the housing 112 such that the lengthwise axis 263 of the light source 222 extends through the light source 222 and intersects a location 225 (e.g., a portion of the first cap 224) distal to the tip 218.

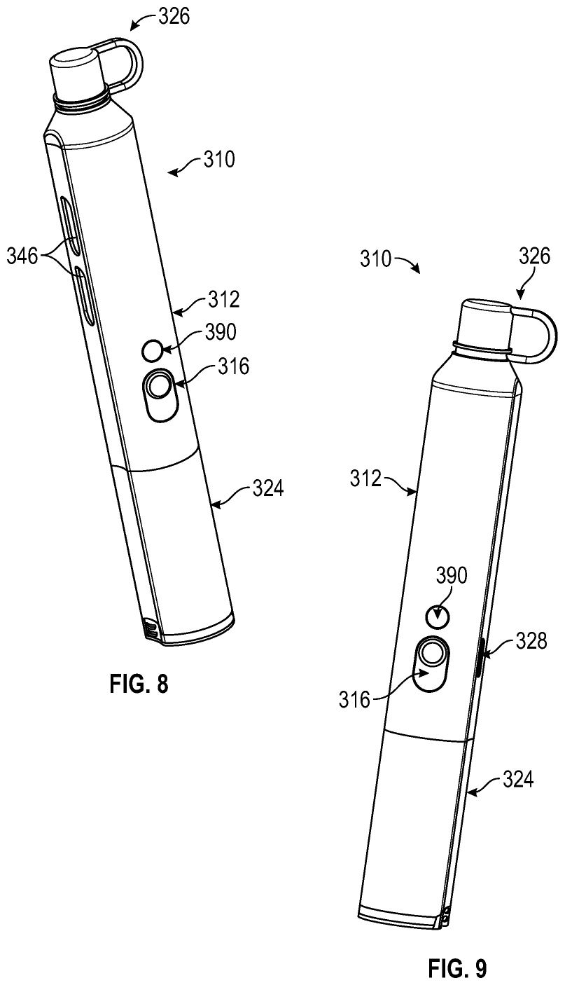

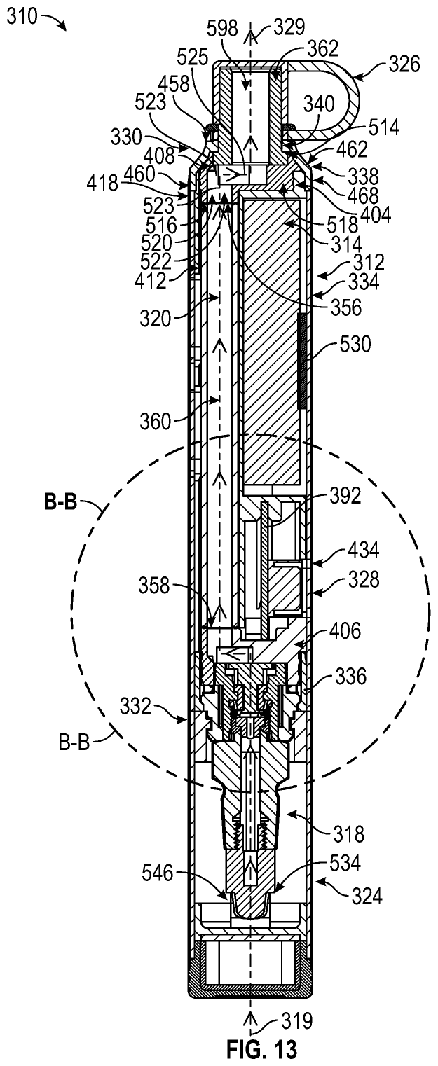

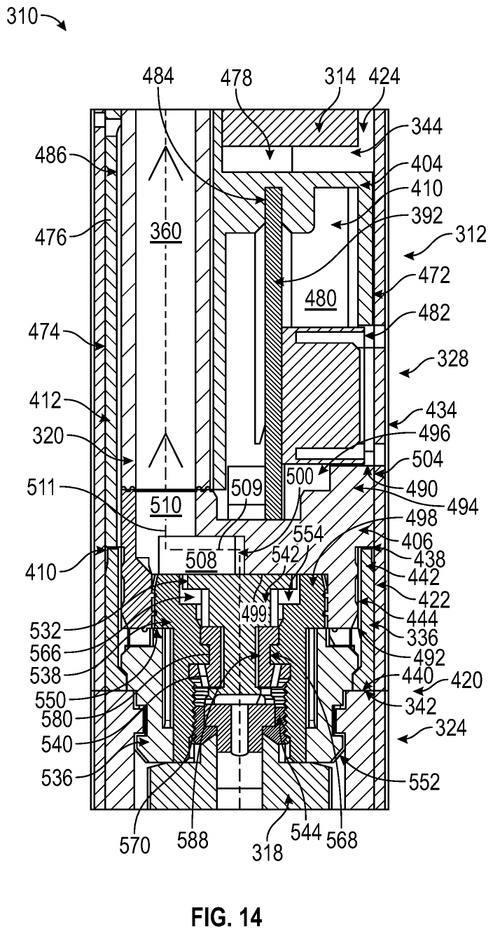

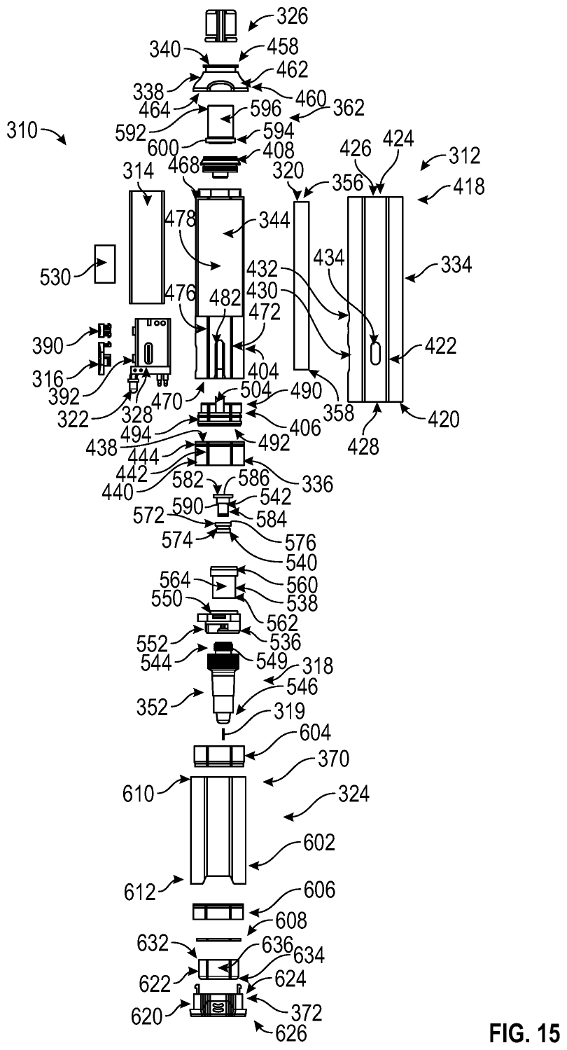

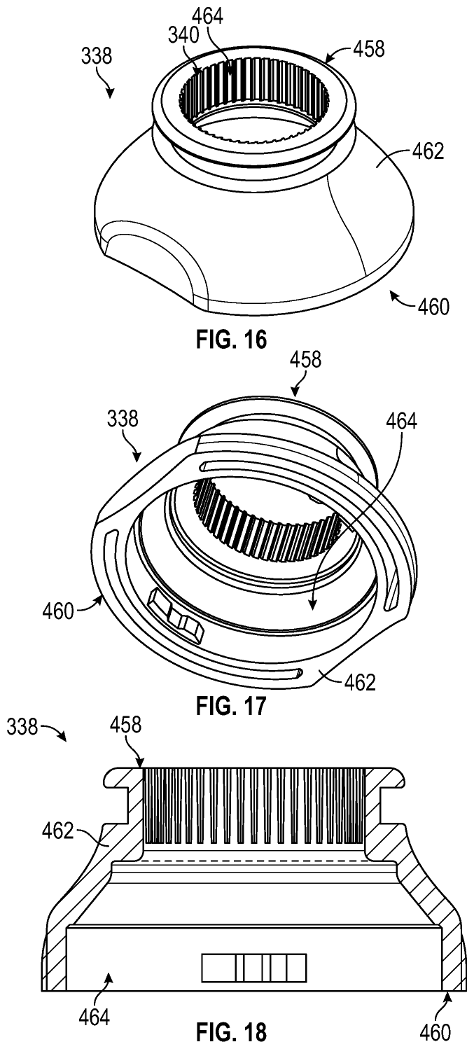

FIGS. 8 through 30 illustrate another example vaporization device 310. The vaporization device 310 is similar to the vaporization device 210 illustrated in FIG. 7 described above, except as detailed below. In the illustrated embodiment, the vaporization device 310 has a housing 312, a power source 314, a first switch 316, a tip 318, an elongate tubular member 320, a light source 322, a first cap 324, a second cap 326, a charging port 328, a mouthpiece 362, a second switch 390, and a PCBA 392. Each of these components is shown in more detail in FIGS. 11 through 14.

In the embodiment illustrated, the housing 312 has a lengthwise axis 329, a first end 330, a second end 332, a sidewall 334, a bottom wall 336, a top wall 338, a bracket 404, a first sealing member 406, a second sealing member 408, and defines a first opening 340 at the first end 330, a second opening 342 at the second end 332, a first chamber 344, a second chamber 410, a third chamber 412, a plurality of windows 346, and a passageway 348.

In the illustrated embodiment, the sidewall 334 has a first end 418, a second end 420, and a main body 422 that defines the plurality of windows 346, a lumen 424, a first opening 426, a second opening 428, a third opening 430, a fourth opening 432, and a fifth opening 434. Each window of the plurality of windows 346 provides access to the third chamber 412 and allows for visualization of the elongate tubular member 320 during use. For example, each window of the plurality of windows 346 provides a mechanism for determining if the elongate tubular member 320 requires cleaning. In the illustrated embodiment, a material (e.g., glass, plastic) is disposed over each window of the plurality of windows 346 to prevent contaminants from entering the first chamber 344.

The lumen 424 extends from the first end 418 to the second end 420 and from the first opening 426 to the second opening 428. In the illustrated embodiment, the second opening 428 of the sidewall 334 is the second opening 342 of the housing 312. The first opening 426 is sized and configured to receive a portion of the second sealing member 408 and the bracket 404 and the second opening 428 is sized and configured to receive a portion of the tip 318 and the bottom wall 336. Each of the third opening 430, the fourth opening 432, and fifth opening 434 extends through the main body 422 of the sidewall 334 and provides access to the lumen 424. The third opening 430 is sized and configured to receive a portion of the first switch 316. The fourth opening 432 is sized and configured to receive a portion of the second switch 390. The fifth opening 434 is sized and configured to receive a portion of the charging port 328.

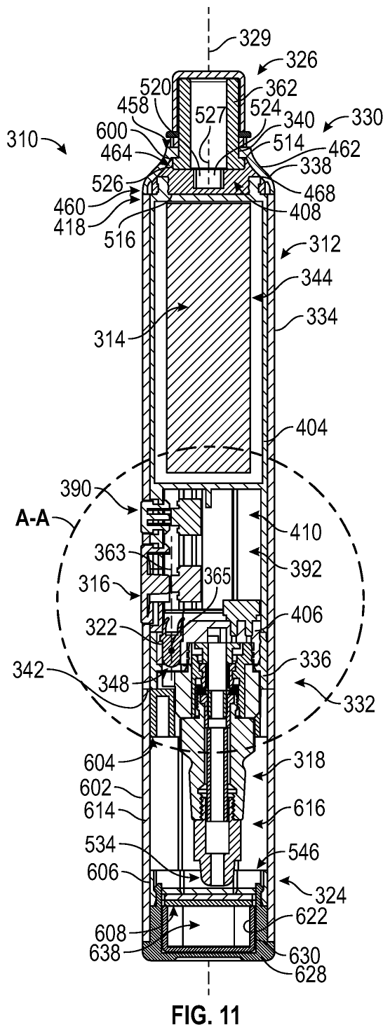

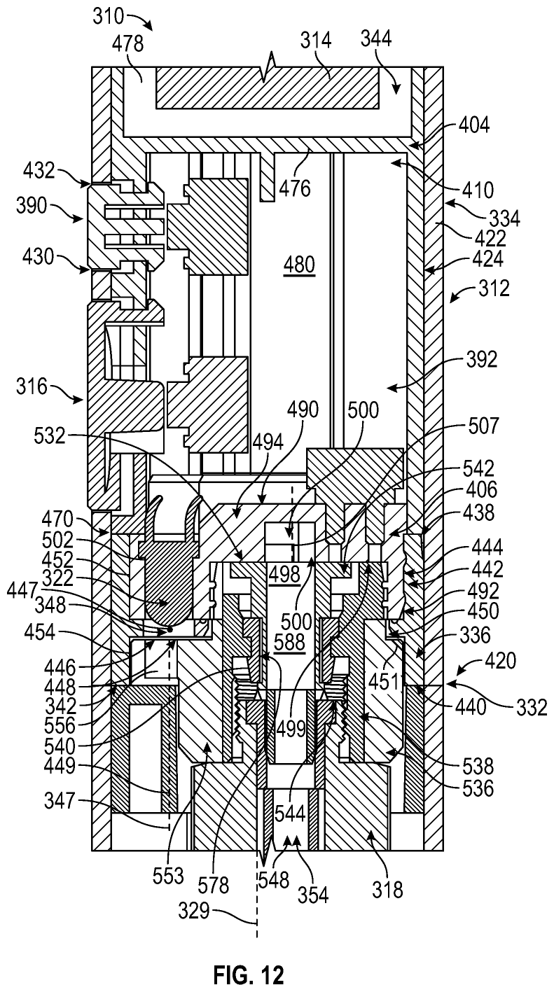

The bottom wall 336 is attached to the sidewall 334 within the lumen 424. The bottom wall 336 has a first end 438, a second end 440, and a main body 442 that defines a lumen 444, a separating wall 446, a first passageway 448, and a second passageway 450. The lumen 444 extends from the first end 438 to the second end 440. The separating wall 446 is disposed within the lumen 444 and between the first and second ends 438, 440. Each of the first and second passageways 448, 450 is defined on the separating wall 444 and provides access between a first portion 452 of the lumen 444 and a second portion 454 of the lumen 444. In the embodiment illustrated, the first passageway 448 is the passageway 348 defined by the housing 312. The first passageway 448 has a center 447, has a lengthwise axis 449, and is in fluid communication with the second chamber 410 (e.g., extends from the second chamber 410 to an environment exterior 349 to the second chamber 410 when the first cap 324 if free of attachment to the housing 312). The lengthwise axis 449 of the first passageway 448 extends through the first passageway 448, through the center 447, and is disposed parallel to the lengthwise axis 329 of the housing 312. In the illustrated embodiment, the lengthwise axis 449 extends through the first passageway 448, through the center 447, and is adjacent to the tip 318 such that the lengthwise axis 449 of the first passageway 448 does not intersect the tip 318, as shown in FIG. 12.

As shown in FIG. 12, the separating wall 446 is disposed at an angle 451 relative to the sidewall 334. In the illustrated embodiment, the angle 451 is about 90 degrees. The first passageway 448 has a diameter that is less than the diameter of the second passageway 450. The first passageway 448 is sized and configured to receive a portion of the light source 322, as described in more detail herein. The second passageway 450 is sized and configured to receive a portion of the tip 318, as described in more detail herein. Attachment between a bottom wall and a sidewall can be accomplished using any suitable type of attachment and selection of a suitable type of attachment can be based on various considerations, such as the material forming a bottom wall and/or sidewall. In the illustrated embodiment, the bottom wall 336 is attached to the sidewall 334 using an adhesive.

As shown in FIGS. 11 and 16 through 18, the top wall 338 is attached to the bracket 404 and disposed on the first end 418 of the sidewall 334. The top wall 338 has a first end 458, a second end 460, and a main body 462 that defines a lumen 464. In the illustrated embodiment, the opening on the first end 458 of the top wall 338 is the first opening 340 of the housing 312. The lumen 464 extends from the first end 458 to the second end 460. Attachment between a top wall and a bracket can be accomplished using any suitable type of attachment and selection of a suitable type of attachment can be based on various considerations, such as the material forming a top wall and/or a bracket. In the illustrated embodiment, the top wall 338 is attached to the bracket 404 using snap-fit attachment.

The bracket 404 is disposed within the lumen 424 defined by the sidewall 334. The bracket 404 has a first end 468, a second end 470, a first side 472, a second side 474 opposably facing the first side 472, and a main body 476 that defines a first recess 478, a second recess 480, a first slot 482, a second slot 484, and a lumen 486. The first end 468 defines structure for accomplishing a snap fit attachment with the top wall 338. The first recess 478 extends from the first side 472 toward the second side 474, is disposed between the first end 468 and the second recess 470, and is sized and configured to house the power source 314. The second recess 480 extends from the second end 470 toward the first end 468 and is sized and configured to house the PCBA 392. The first slot 482 extends from the second end 470 toward the first end 468 and provides access between the second recess 480 and an environment exterior 349 to the second recess 480. The first slot 482 is sized and configured to receive a portion of the charging port 328 and the first sealing member 406. The second slot 484 is disposed within the second recess 480 is sized and configured to receive a portion of the PCBA 392. The lumen 486 extends from the first end 468 to the second end 470 and is disposed between the second side 474 and the first and second recesses 478, 480. The lumen 486 is sized and configured to receive the elongate tubular member 320. Attachment between a bracket and a sidewall can be accomplished using any suitable type of attachment and selection of a suitable type of attachment can be based on various considerations, such as the material forming a bracket and/or a sidewall. In the illustrated embodiment, the bracket 404 is attached to the sidewall 334 using the first and second sealing members 406, 408 (e.g., the first and second sealing members 406, 408 compress to maintain the position of the bracket 404 within the lumen 424 defined by the sidewall 334).

The first sealing member 406 is disposed between the bottom wall 336 and the bracket 404 and within the lumen 424 defined by the sidewall 334. The first sealing member 406 has a first end 490, a second end 492, and a main body 494 that defines a first recess 496, a second recess 498, a first lumen 500, a second lumen 502, and a projection 504. The first recess 496 extends from the first end 490 toward the second end 492 and is sized and configured to receive a portion of the PCBA 392. The second recess 498 extends from the second end 492 toward the first end 490 and is sized and configured to receive a portion of the tip 318. The first lumen 500 extends from the base 499 of the second recess 498 toward the first end 490 and is in fluid communication with the passageway 354 defined by the tip 318 and the passageway 360 defined by the elongate tubular member 320. The first lumen 500 has a first portion 506, a second portion 508, and a third portion 510. The first portion 506 extends from the base 499 of the second recess 498 to the second portion 508. The second portion 508 extends from the first portion 506 to the third portion 510. The third portion 510 extends from the second portion 508 to the first end 490. The first portion 506 has a first lengthwise axis 507, the second portion 508 has a second lengthwise axis 509, and the third portion 510 has a third lengthwise axis 511. Each of the first lengthwise axis 507 and the third lengthwise axis 511 is parallel to the lengthwise axis 329 of the housing 312. The second lengthwise axis 509 is disposed at an angle to the first and third lengthwise axes 507, 511 such that fluid (e.g., vapor from a consumable product) can travel through the first lumen 550, from the tip 318 to the elongate tubular member 320, and from the elongate tubular member 320 to the mouthpiece 362. The second lumen 502 extends from the first end 490 to the second end 492 and is sized and configured to receive a portion of the light source 322. The projection 504 extends from the first end 490 and away from the second end 492 and is partially disposed within the first slot 482 defined by the bracket 404. The first sealing member 406 is formed of a compressible material (e.g., silicone) and contacts the bracket 404, the PCBA 392, the elongate tubular member 320, and the tip 318 such that each of these components can be maintained in its relative position.

The second sealing member 408 is disposed between the top wall 338 and the bracket 404, within the lumen 424 defined by the sidewall 334, and within the lumen 464 defined by the top wall 338. As shown in FIGS. 19 and 20, the second sealing member 408 has a first end 514, a second end 516, and a main body 518 that defines a lumen 520. The lumen 520 extends from the first end 514 to the second end 516 and is in fluid communication with the passageway 360 defined by the elongate tubular member 320. The lumen 520 has a first portion 522, a second portion 524, and a third portion 526. The first portion 522 extends from the second end 516 to the second portion 524. The second portion 524 extends from the first portion 522 to the third portion 526. The third portion 526 extends from the second portion 524 to the first end 514. The first portion 522 has a first lengthwise axis 523, the second portion 524 has a second lengthwise axis 525, and the third portion 526 has a third lengthwise axis 527. Each of the first lengthwise axis 523 and the third lengthwise axis 527 is parallel to the lengthwise axis 329 of the housing 312. The second lengthwise axis 525 is disposed at an angle to the first and third lengthwise axes 523, 527 (e.g., 90 degrees, between 60 degrees and about 120 degrees) such that fluid (e.g., vapor from a consumable product) can travel through the lumen 520 and from the passageway 360 of the elongate tubular member 320 to the mouthpiece 362. The second sealing member 408 is formed of a compressible material (e.g., silicone) and contacts the bracket 404, the elongate tubular member 320, the top wall 338, and the mouthpiece 362 such that each of these components can be maintained in its relative position.

In the illustrated embodiment, the first chamber 344 is cooperatively defined by the bracket 404 and the sidewall 334, the second chamber 410 is cooperatively defined by the bracket 404 and the first sealing member 406, and the third chamber 412 is cooperatively defined by the bracket 404, the first sealing member 406, and the second sealing member 408. Each of the first chamber 344, the second chamber 410, and the third chamber 412 is disposed between the first end 330 and the second end 332 of the housing 312. The first chamber 344 is disposed between the first and second ends 468, 470 of the bracket 404. The second chamber 410 is disposed between the first chamber 344 and the first sealing member 406. The third chamber 412 extends through the entire length of the bracket 404 and from the first sealing member 406 to the second sealing member 408.

The power source 314 is disposed on the housing 312 and is electrically connected to the PCBA 392, the tip 318 via the PCBA 392, and the light source 322 via the PCBA 392. In the illustrated embodiment, the power source 314 is disposed within the first chamber 344 and a cushion 530 is disposed between the power source 314 and the sidewall 334. A cushion can be formed of any suitable material and selection of a suitable material can be based on various considerations, such as the type of power source included in a vaporization device. Examples of materials considered suitable to form a cushion include ethylene vinyl acetate (EVA), and any other material considered suitable for a particular embodiment. Optionally, a cushion can be omitted from a vaporization device.

The first switch 316 is disposed on the housing 312 and is connected to the PCBA 392. In the embodiment shown, the first switch 316 is attached to the bracket 404, is disposed within the third opening 430 defined by the sidewall 334, and is accessible by a user. The first switch 316 has a first configuration and a second configuration and can be selectively activated by a user. The heating element 352 is in the off state when the first switch 316 is in the first configuration. The heating element 352 is in the on state when the first switch 316 is in the second configuration. In the illustrated embodiment, the first switch 316 comprises a slide switch 350 and is shown in the first configuration in FIG. 8.

The tip 318 is disposed on the second end 332 of the housing 312. The tip 318 has a lengthwise axis 319, a first end 532, a second end 534, includes a heating element 352, a base 536, a threaded member 538, an insulating ring 540, an electrode 542, and defines a passageway 354 that extends from the first end 532 to the second end 534. The tip 318 is electrically connected to the power source 314 via the PCBA 392 and the electrode 542, is connected to the first switch 316, and is configured to heat a consumable product (e.g., oil, wax, concentrate, combustible plant substance) using the heating element 352 to create a vapor for a user to inhale.

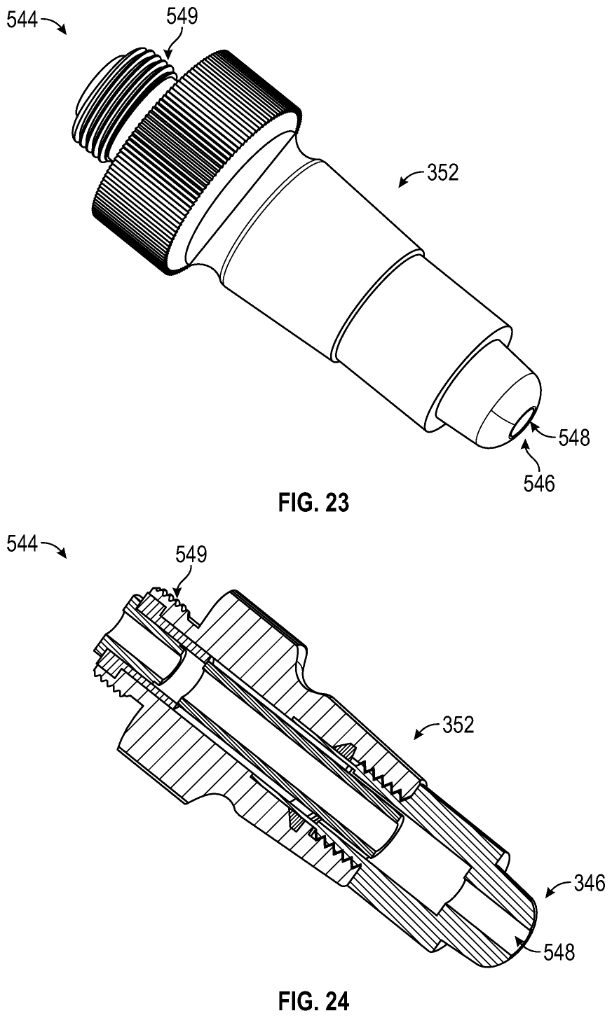

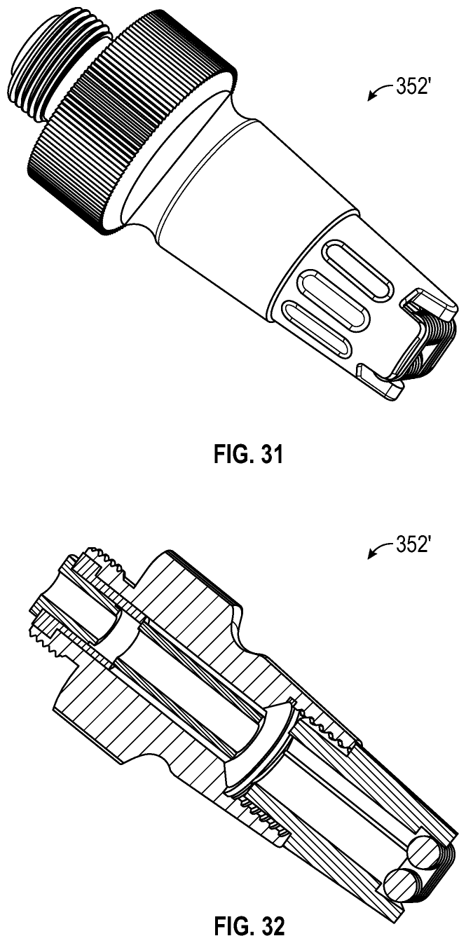

As shown in FIGS. 23 and 24, the heating element 352 has a first end 544, a second end 546, and defines a lumen 548 and a thread 549. The lumen 548 extends from the first end 544 to the second end 546. The thread 549 extends from the first end 544 toward the second end 546 and is sized and configured to mate with the thread 570 defined by the threaded member 538. FIGS. 31 and 32 illustrate an alternative heating element 352′ of a tip of a vaporization device.

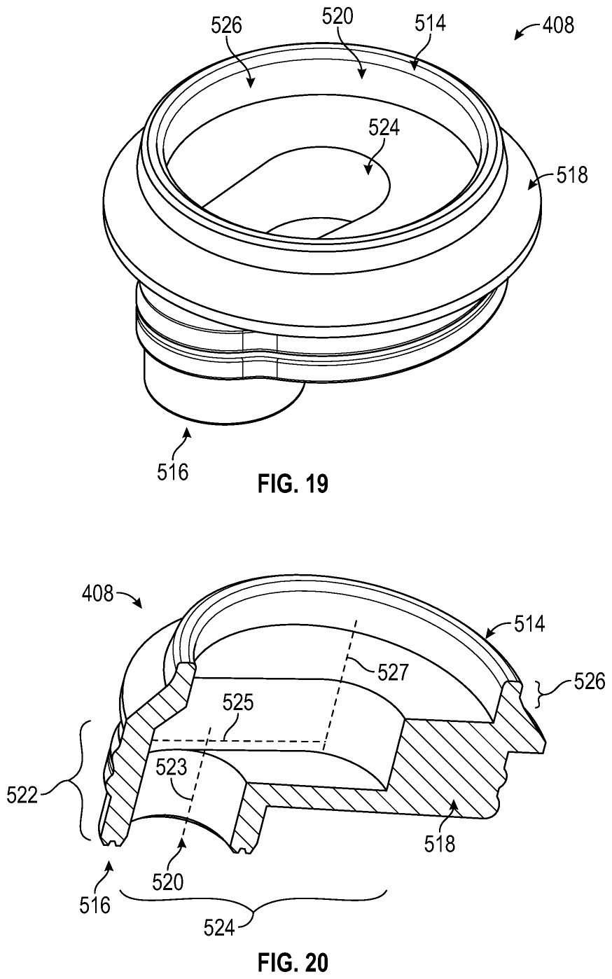

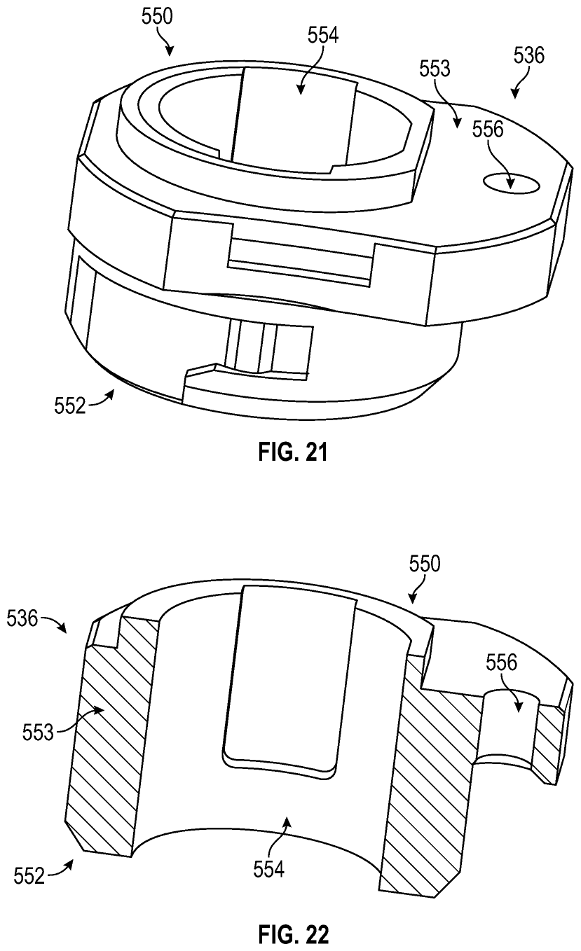

The base 536 is disposed between the heating element 352 and the threaded member 538. As shown in FIGS. 21 and 22, the base 536 has a first end 550, a second end 552, and a main body 553 that defines a first lumen 554 and a second lumen 556. The first lumen 554 extends from the first end 550 to the second end 552. The first lumen 554 is in fluid communication with the lumen 548 defined by the heating element 352. The second lumen 556 is disposed adjacent to the first lumen 554 and is aligned with the passageway 348 defined by the housing 312 (e.g., a central axis of the second lumen 556 extends through the passageway 348 defined by the housing 312) such that direct light from the light source 322 can pass through the second lumen 556 when the light source 322 is in the on state. Alignment between the second lumen 556 and the passageway 348 defined by the housing 312 can be accomplished using any suitable structure and/or method. In the illustrated embodiment, the first portion 452 of the lumen 444 of the bottom wall 336 is configured to mate with the structure of the base 536 to accomplish alignment between the second lumen 556 and the passageway 348 defined by the housing 312.

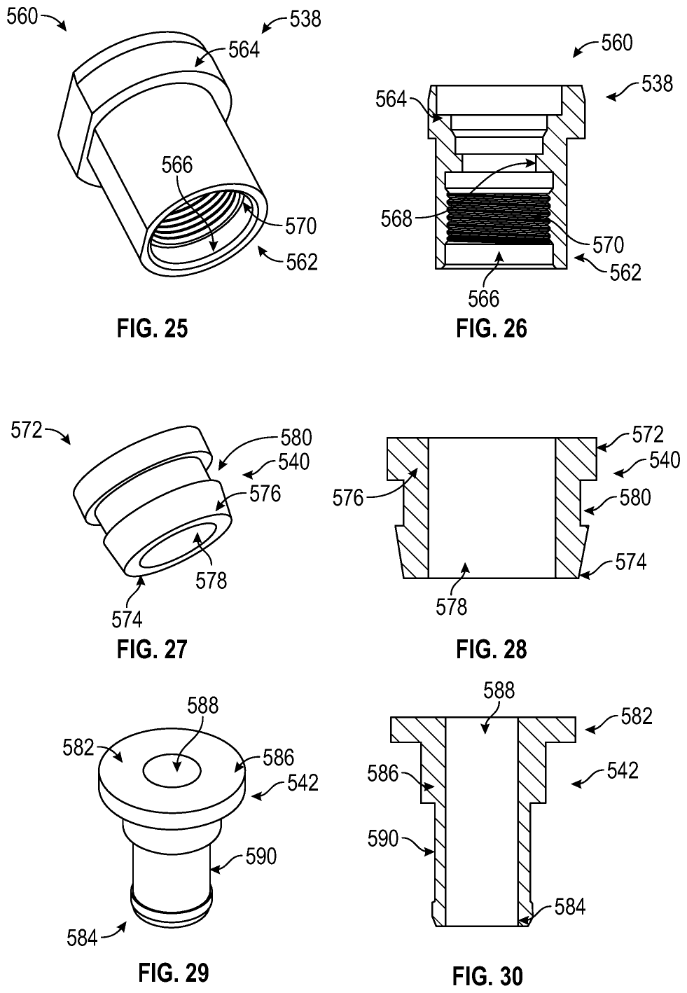

The threaded member 538 is disposed between the heating element 352 and the first sealing member 406 and within the first lumen 554 defined by the base 536. As shown in FIGS. 25 and 26, the threaded member 538 has a first end 560, a second end 562, and a main body 564 that defines a lumen 566, a projection 568, and a thread 570. The lumen 566 extends from the first end 560 to the second end 562 and is in fluid communication with the lumen 548 defined by the heating element 352. The projection 568 extends into the lumen 566 and is disposed within the recess 580 of the insulating ring 540, as described in more detail herein, to accomplish releasable attachment between the threaded member 538 and the insulating ring 540. The thread 570 is disposed between the projection 568 and the second end 562 and is sized and configured to mate with the thread 549 of the heating element 352 to accomplish releasable attachment between the two components.

The insulating ring 540 is disposed within the lumen 564 defined by the threaded member 538 and within the recess 590 defined by the electrode 542, as described in more detail herein. As shown in FIGS. 27 and 28, the insulating ring 540 has a first end 572, a tapered second end 574, and a main body 576 that defines a lumen 578 and a recess 580. The lumen 578 extends from the first end 572 to the tapered second end 574 and is in fluid communication with the lumen 548 defined by the heating element 352. The recess 580 is disposed between the first end 572 and the tapered second end 574 and is sized and configured to receive a portion of the projection 568 to accomplish releasable attachment between the insulating ring 540 and the threaded member 538.

The electrode 542 (e.g., resistive electrode) is disposed within the lumen 578 defined by the insulating ring 540. As shown in FIGS. 29 and 30, the electrode 542 has a first end 582, a second end 584, and a main body 586 that defines a lumen 588 and a recess 590. The lumen 588 extends from the first end 582 to the second end 584 and is in fluid communication with the lumen 548 defined by the heating element 352. The recess 590 is disposed between the first end 582 and the second end 584 and is sized and configured to receive a portion of the insulating ring 540 to accomplish releasable attachment between the insulating ring 540 and the electrode 542. The electrode 542 is electrically connected to the power source 314 via the PCBA 392, is connected to the first switch 316, and can be activated by the power source 314 upon selective activation of the first switch 316 by a user. The electrode 542 and the heating element 352 (e.g., via the electrode 542) are moveable between an on state and an off state by the power source 314 upon selective activation of the first switch 316. The electrode 542 and the heating element 352 generate heat when the first switch 316 is in the second configuration. This results in a user being able to heat a consumable product using direct heat. The passageway 354 extends through the tip 318 and is in fluid communication with the passageway 360 defined by the elongate tubular member 320 via the first lumen 500 of the first sealing member 406. In the illustrated embodiment, the passageway 354 is cooperatively defined by heating element 352, the threaded member 538, and the electrode 542.

The elongate tubular member 320 is disposed within the lumen 486 defined by the bracket 404 and, in the illustrated embodiment, is entirely disposed within the third chamber 412. The elongate tubular member 320 has a first end 356, a second end 358, and defines a passageway 360. The first end 356 contacts the second sealing member 408 such that the passageway 360 defined by the elongate tubular member 320 is in fluid communication with the lumen 520 defined by the second sealing member 408. The second end 358 contacts the first sealing member 406 such that the passageway 360 defined by the elongate tubular member 320 is in fluid communication with the first lumen 500 defined by the first sealing member 406.

In the illustrated embodiment, the mouthpiece 362 is partially disposed within the lumen 464 defined by the top wall 338 and between the top wall 338 and the second sealing member 408. The mouthpiece 362 has a first end 592, a second end 594, and a main body 596 that defines a lumen 598 and a projection 600. The lumen 598 extends from the first end 592 to the second end 594 and is in fluid communication with the lumen 520 defined by the second sealing member 408. The projection 600 extends from the main body 596 and away from the lumen 598 and has an outside diameter that is greater than the inside diameter of the lumen 464 of the top wall 338 at the first end 458.

The light source 322 has a lengthwise axis 363, a center 365, is disposed on the housing 312, and is moveable between an on state and an off state. The light source 322 is disposed between the first end 330 and the second end 332 of the housing 312, on the PCBA 392, and is electrically connected to the power source 314 via the PCBA 392 and is connected to the second switch 390 via the PCBA 392. The light source 322 can be moved between the off state and the on state by the power source 314 upon selective activation of the second switch 390 by a user. When activated, the light source 322 emits direct light away from the first end 330 of the housing 312. In the illustrated embodiment, when activated, the light source 322 emits light from the second end 332 of the housing 312 and through the passageway 348 of the housing 312 (e.g., second passageway of the bottom wall 336) the second lumen 556 of the base 536 and direct light is directed parallel to the tip 318 (e.g., does not directly strike the tip 318) and strikes a location distal to the tip 318. In the embodiment shown, when a user selectively activates the second switch 390 the light source 322 is activated.

The light source 322 is positioned within the passageway 348 of the housing 312 such that the lengthwise axis 363 of the light source 322 extends through the light source 322 (e.g., center 365 of light source 322), through passageway 348 of the housing 112, and is parallel the lengthwise axis 329 of the housing 312. In the illustrated embodiment, the light source 322 is partially disposed within the passageway 348 of the housing 312 such that the lengthwise axis 363 of the light source 322 extends through the light source 322 (e.g., center 365 of light source 322), through passageway 348 of the housing 312, and is parallel to the lengthwise axis 319 of the tip 318 such that the lengthwise axis 363 of the light source 322 does not intersect the lengthwise axis of the tip 319.

As described herein, the housing 312 and the light source 322 have a specific relative structural arrangement to accomplish direct light being directed away from the first end 330 of the housing 312 and striking a location distal to the tip 318. In the illustrated embodiment, the lengthwise axis 347 of the passageway 348 (e.g., lengthwise axis 449) and the lengthwise axis 363 of the light source 322 are coaxial and parallel to the lengthwise axis 319 of the tip 318 and the lengthwise axis 329 of the housing 312.

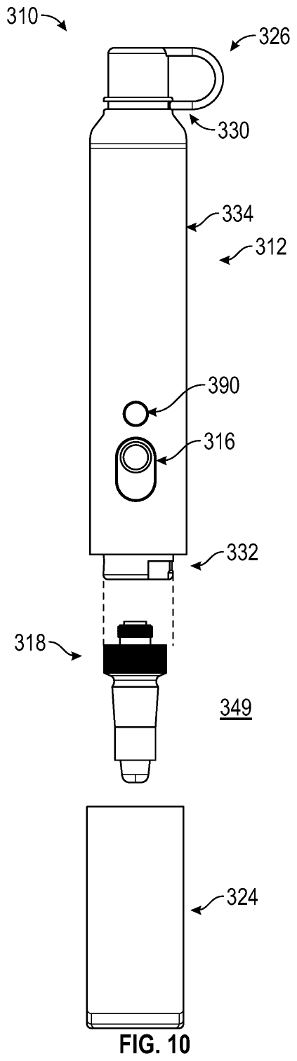

The first cap 324 is disposed on the second end 332 of the housing 312 and has a first portion 370 and a second portion 372. The first cap 324 can be releasably attached to the housing 312, as shown in FIGS. 8 through 10, in which the first portion 370 is releasably attached to the housing 312. Alternatively, the cap 324 can be free of attachment to the housing 312, as shown in FIG. 10, in which the first portion 370 is free of attachment to the housing 312 and is capable of releasable attachment to the housing 312. The first cap 324 is moveable between a first, assembled configuration and a second, disassembled configuration. In the first, assembled configuration, the second portion 372 is releasably attached to the first portion 370. In the second, disassembled configuration, the second portion 372 is free of attachment to the first portion 370 and is capable of releasable attachment to the first portion 370.

In the illustrated embodiment, the first portion 370 has a sidewall 602, a top wall 604, a bottom wall 606, and a gasket 608. The sidewall 602 has a first end 610, a second end 612, and a main body 614 that defines a passageway 616 that extends from the first end 610 to the second end 612. The top wall 604 is disposed within the passageway 616 defined by the sidewall 602 and includes structure for providing a snap fit attachment between the first cap 324 and the tip 318. The bottom wall 606 is disposed within the passageway 616 defined by the sidewall 602 and includes structure for providing a snap fit attachment between the first portion 370 of the first cap 324 and the second portion 372 of the first cap 324. The gasket 608 is disposed within the bottom wall 606 and provides a contact surface for the bowl 622 of the second portion 372, as described in more detail below. When in the first, assembled configuration, the second portion 372 is releasably attached to the second end 378 of the first portion 370.

The second portion 372 has an outer body 620 and a bowl 622. The outer body 620 has a first end 624, a second end 626, and a main body 628 that defines a recess 630 that extends from the first end 624 toward the second end 626. The bowl 622 is disposed within the recess 630 of the outer body 620 and has a first end 632, a second end 634, and a main body 636 that defines a recess 638 that is sized and configured to receive a consumable product and/or a portion of the tip 318. In the embodiment illustrated, the outer body 620 of the second portion 372 is formed of a first material and the bowl 622 is formed of a second material. The second material is different than the first material. In the illustrated embodiment, the first material is an aluminum alloy and the second material is a ceramic.

The second cap 326 is releasably attached to the housing 312 (e.g., top wall 338) and is moveable between a first configuration and a second configuration. In the first configuration, the second cap 326 is disposed over the first end 592 of the mouthpiece 362. In the second configuration, the second cap 326 is not disposed over the first end 592 of the mouthpiece 362. The charging port 328 is electrically connected to the power source 314 via the PCBA 392 and provides a mechanism for charging the power source 314 prior to, or during, use.

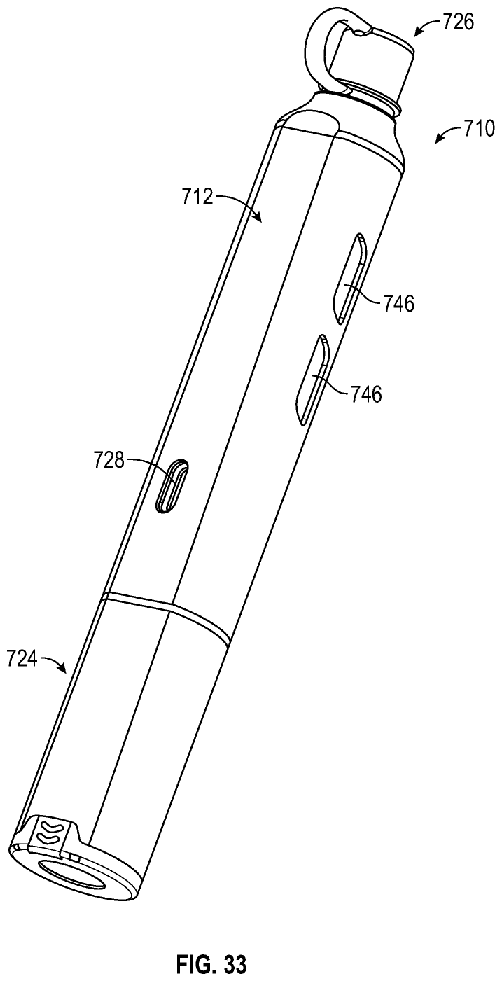

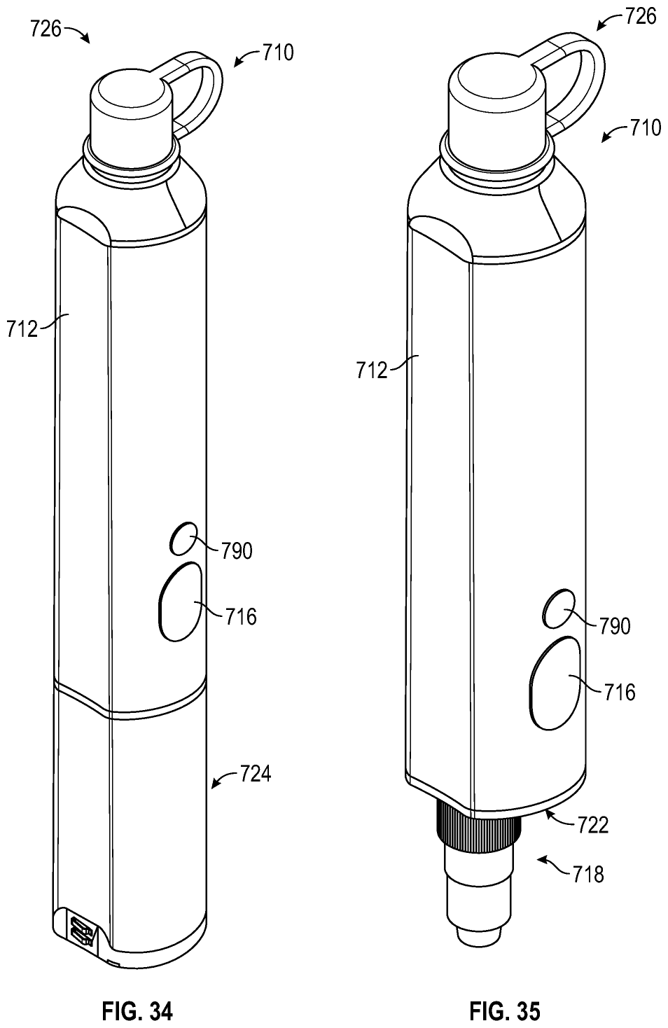

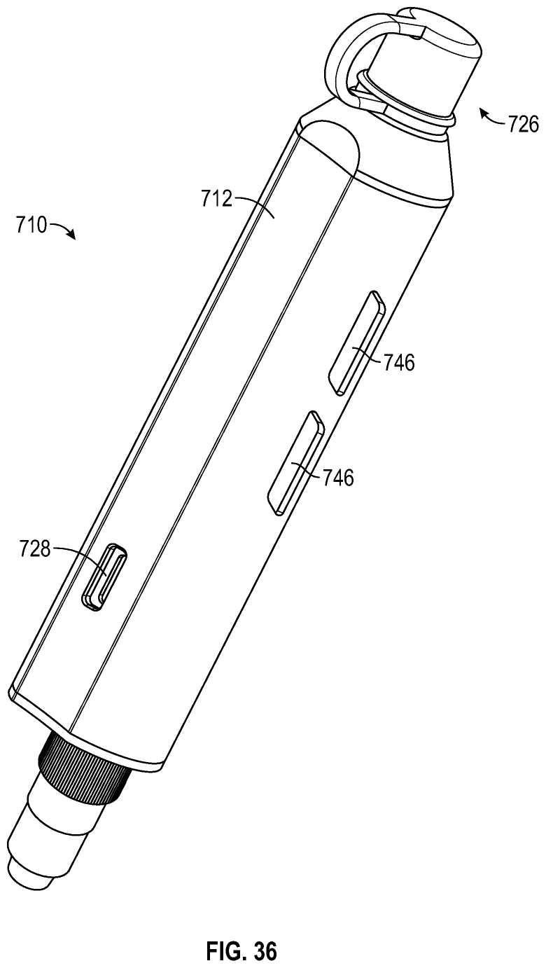

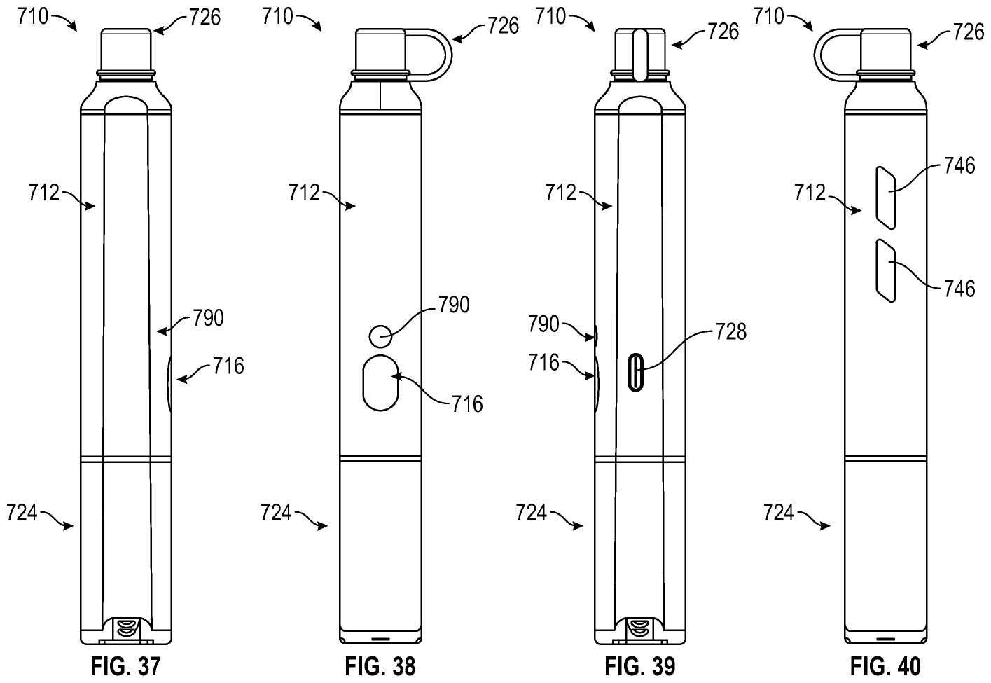

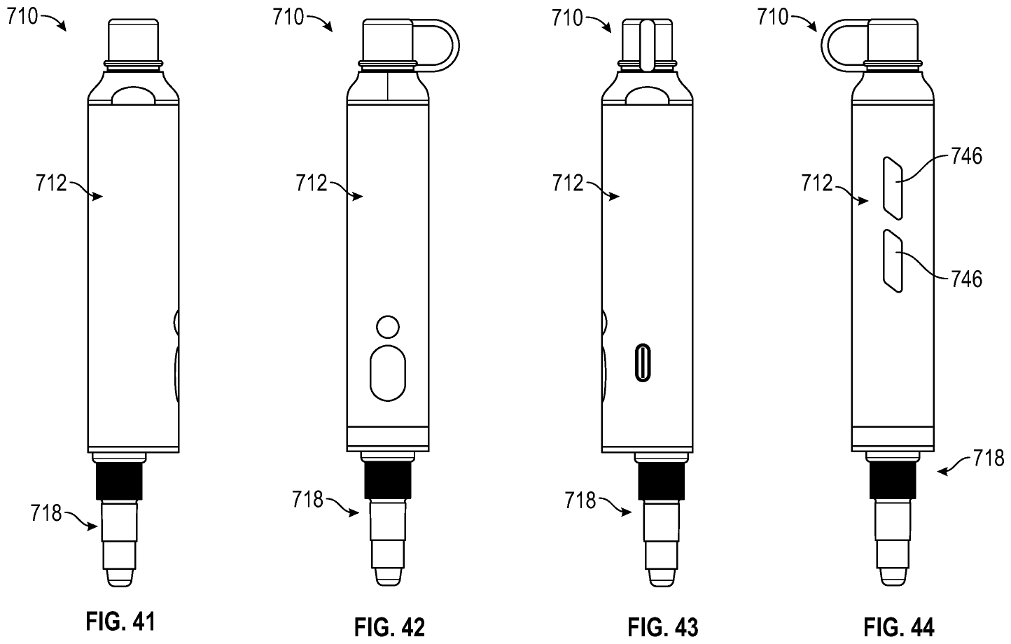

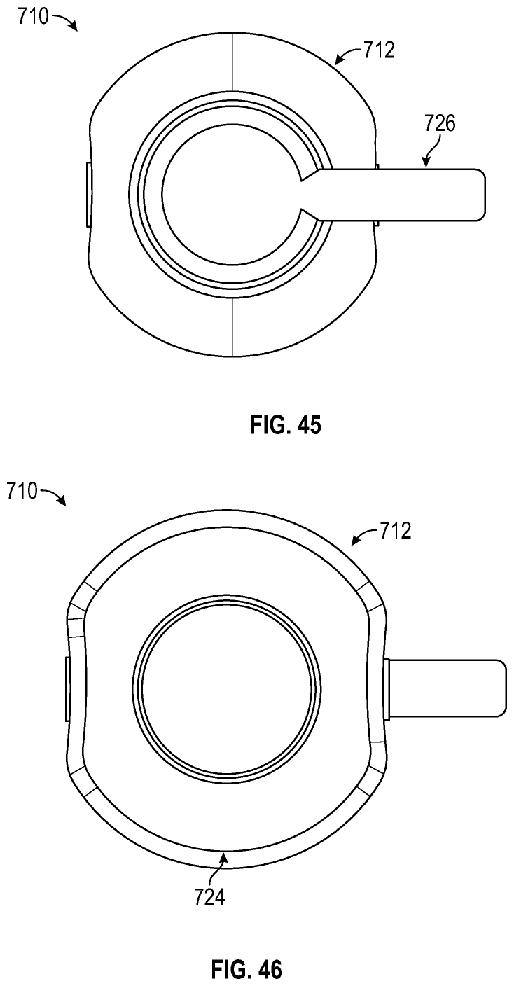

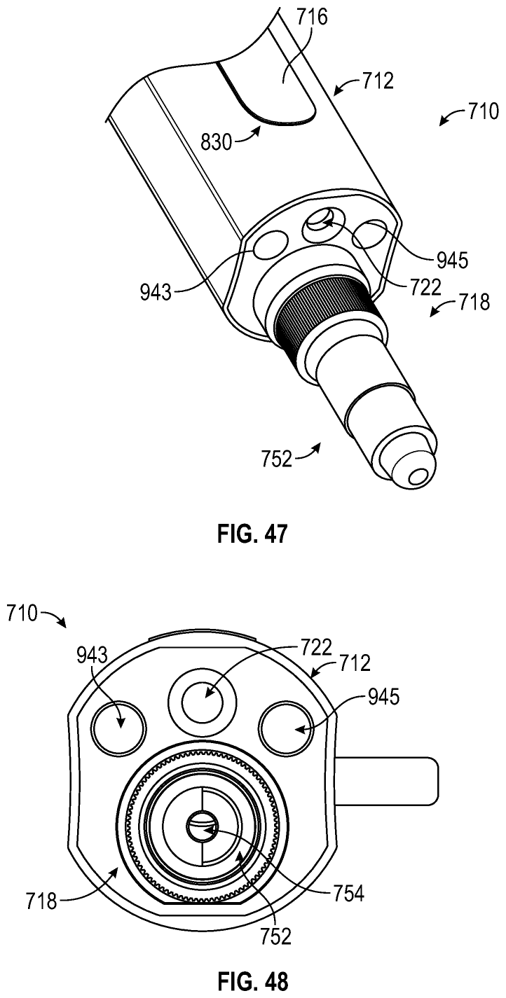

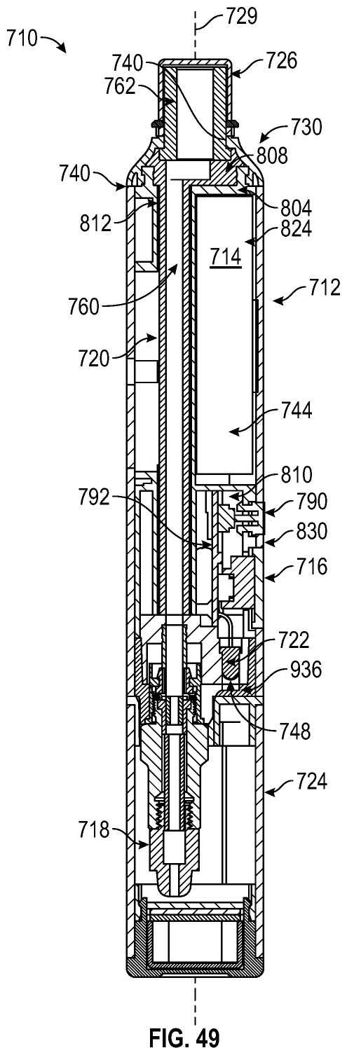

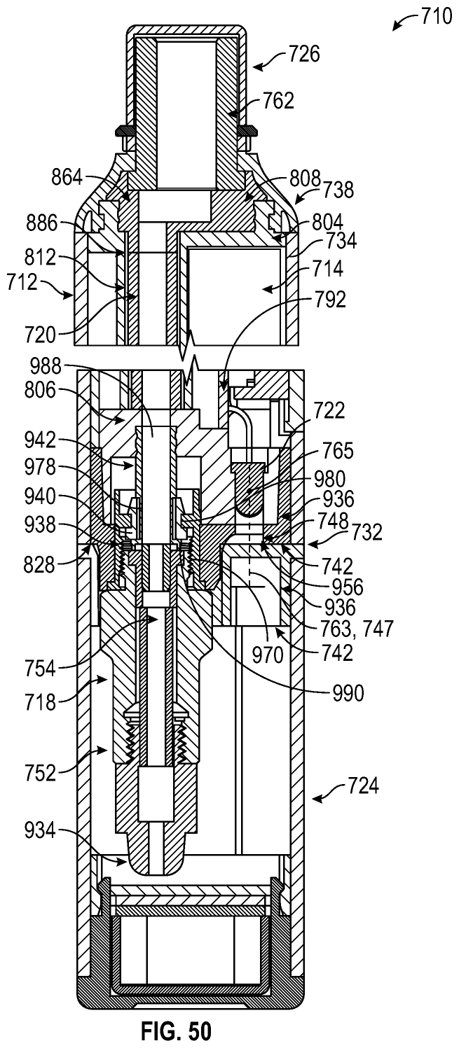

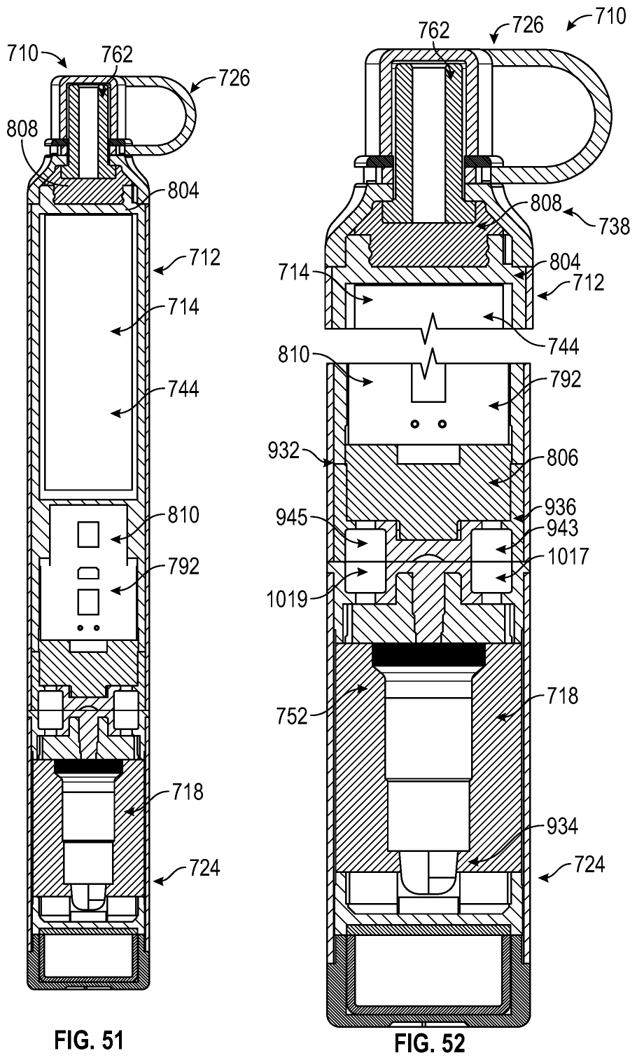

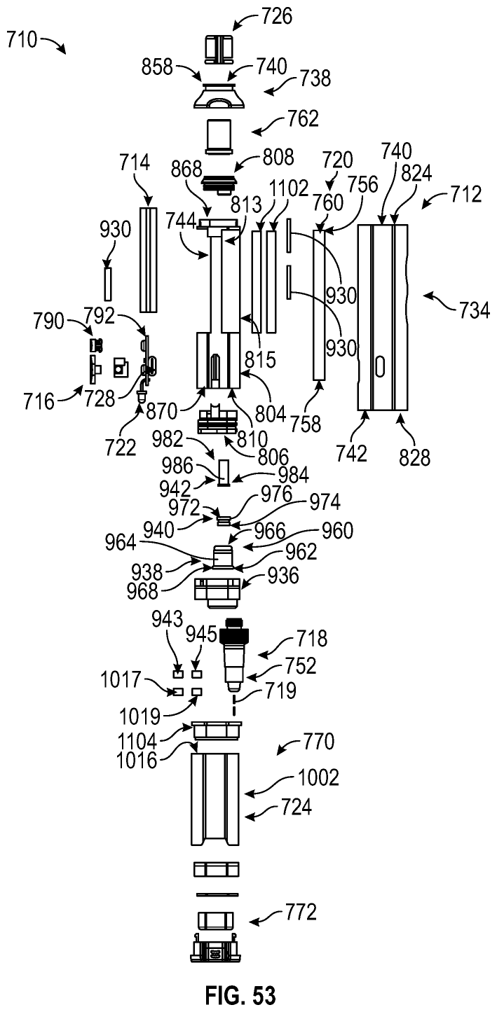

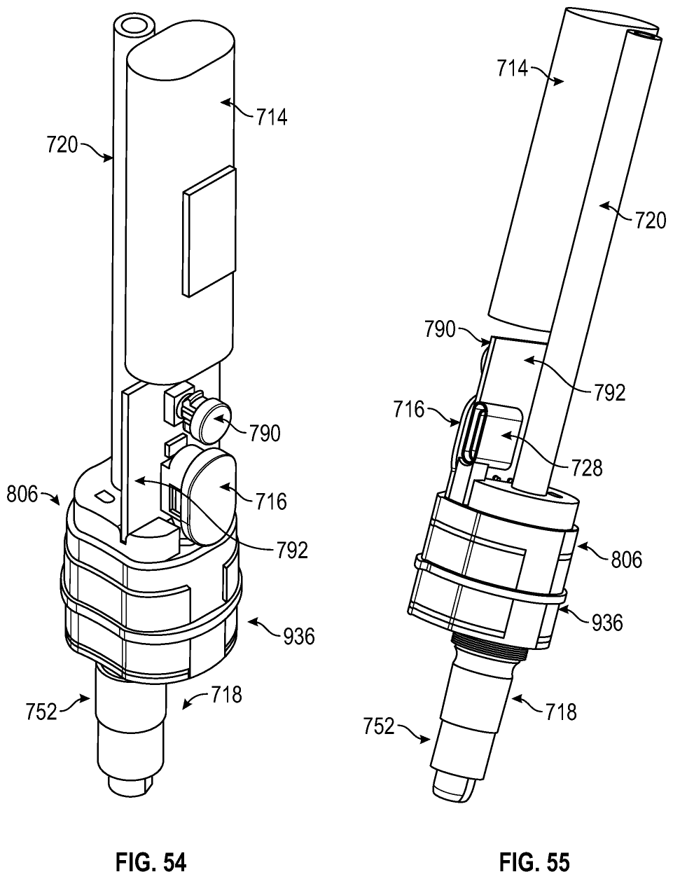

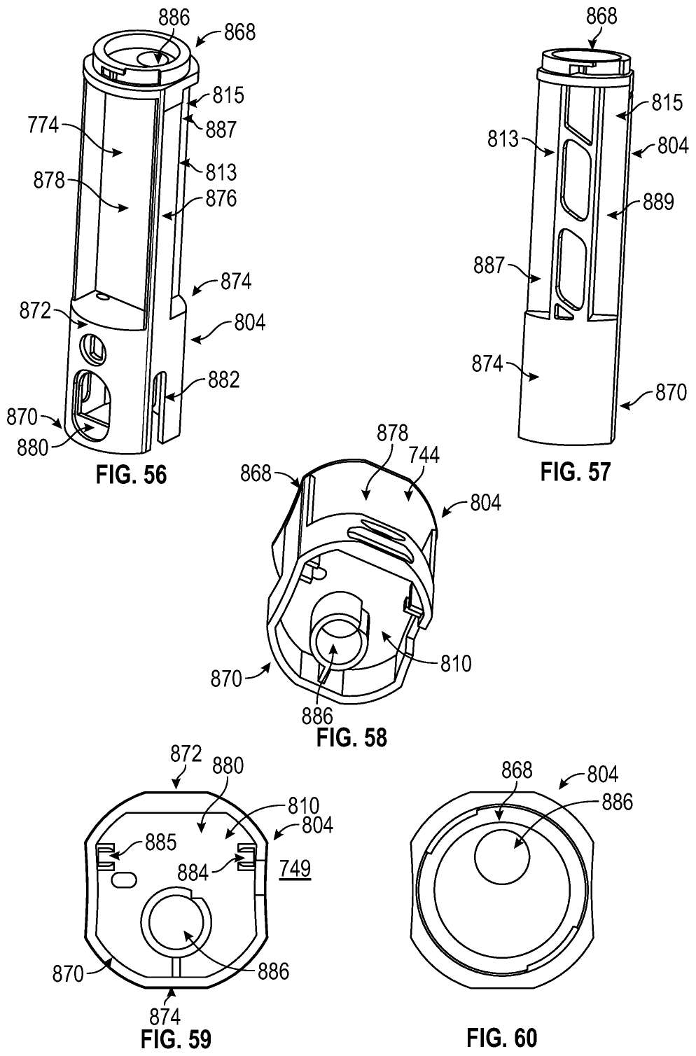

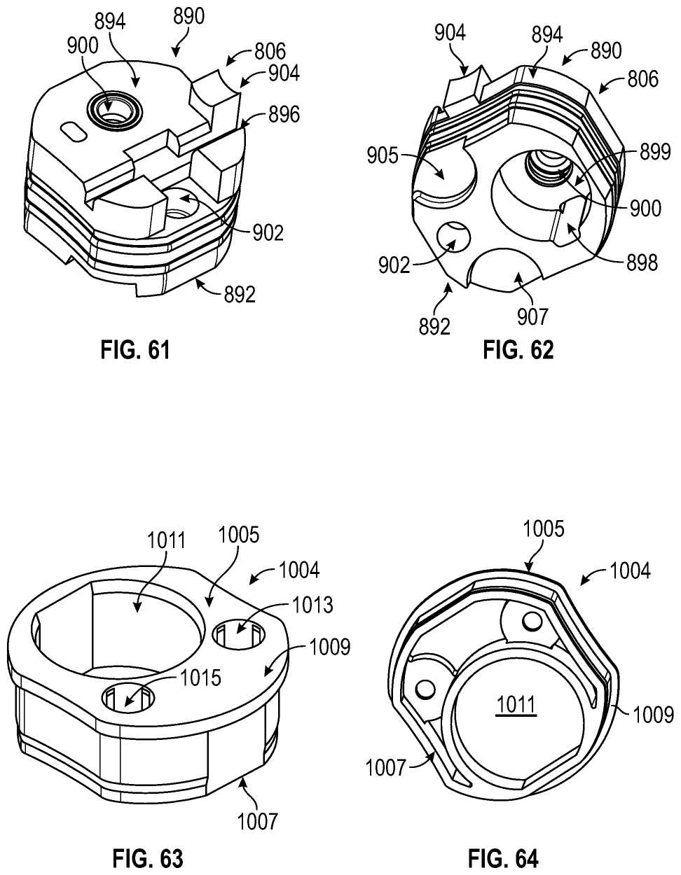

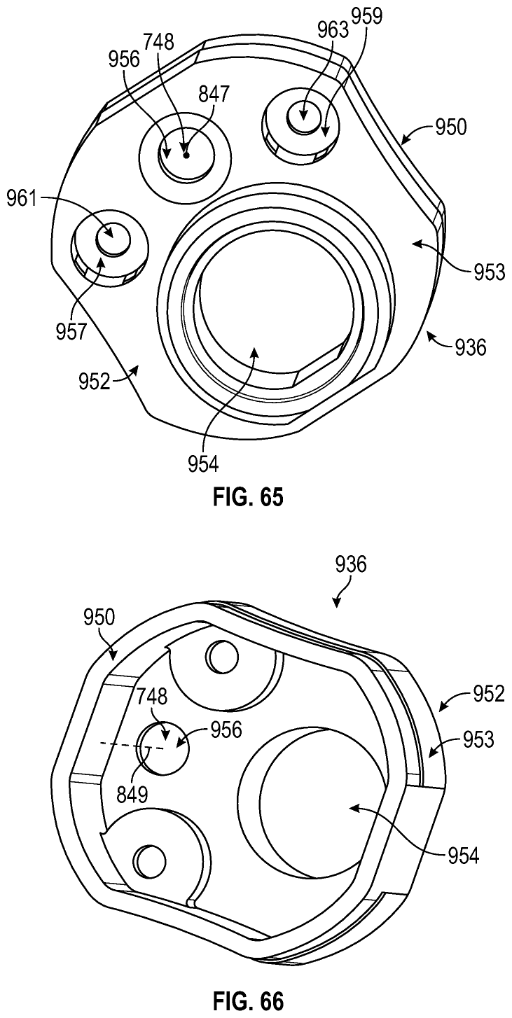

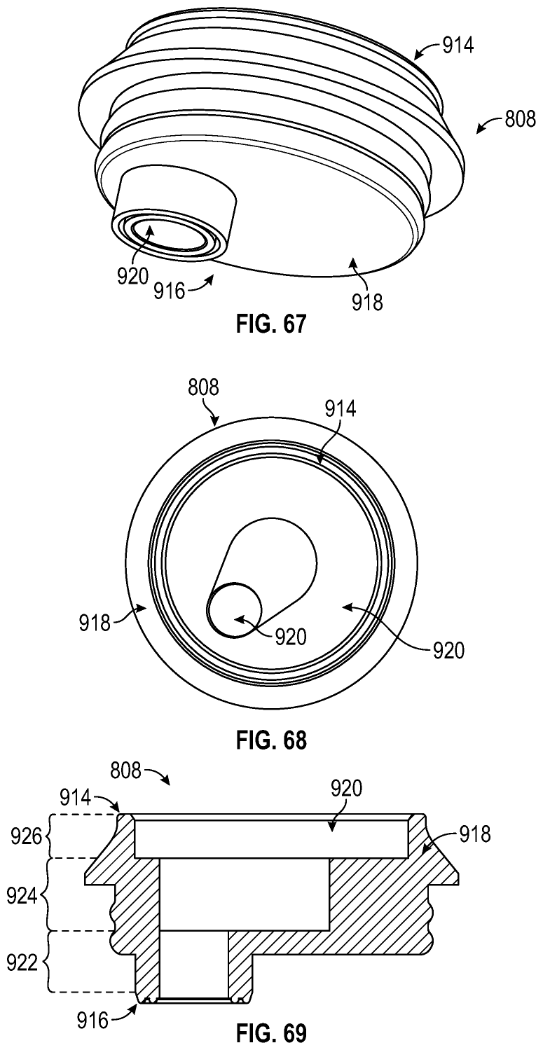

FIGS. 33 through 69 illustrate another example vaporization device 710. The vaporization device 710 is similar to the vaporization device 310 illustrated in FIGS. 8 through 30 described above, except as detailed below. In the illustrated embodiment, the vaporization device 710 has a housing 712, a power source 714, a first switch 716, a tip 718, an elongate tubular member 720, a light source 722, a first cap 724, a second cap 726, a charging port 728, a mouthpiece 762, a second switch 790, a PCBA 792, and a plurality of weighted members 1102.

In the embodiment illustrated, the housing 712 has a lengthwise axis 729, a first end 730, a second end 732, a sidewall 734, a top wall 738, a bracket 804, a first sealing member 806, a second sealing member 808, and defines a first opening 740 at the first end 730, a second opening 742 at the second end 732, a first chamber 744, a second chamber 810, a third chamber 812, a fourth chamber 813, a fifth chamber 815, a plurality of windows 746, and a passageway 748.

In the illustrated embodiment, the second opening 828 of the sidewall 734 is the second opening 742 of the housing 712. The first opening 740 is sized and configured to receive a portion of the second sealing member 808 and the bracket 804 and the second opening 742 is sized and configured to receive a portion of the tip 718, the second sealing member 806, and the base 936 of the tip 718. In the illustrated embodiment, the opening on the first end 858 of the top wall 738 is the first opening 740 of the housing 712.

The bracket 804 is disposed within the lumen 824 defined by the sidewall 734. The bracket 804 has a first end 868, a second end 870, a first side 872, a second side 874 opposably facing the first side 872, and a main body 876 that defines a first recess 878, a second recess 880, a first slot 882, a second slot 884, third slot 885, a lumen 886, a third recess 887, and a fourth recess 889. The first recess 878 extends from the first side 872 toward the second side 874, is disposed between the first end 868 and the second recess 880, and is sized and configured to house the power source 714. The second recess 880 extends from the second end 870 toward the first end 868 and is sized and configured to house the PCBA 792. The first slot 882 extends from the second end 870 toward the first end 868 and provides access between the second recess 880 and an environment exterior 749 to the second recess 880. The first slot 882 is sized and configured to receive a portion of the charging port 728 and the first sealing member 806. The second slot 884 and the third slot 885 are disposed within the second recess 880 and are sized and configured to receive a portion of the PCBA 792. The lumen 886 extends from the first end 868 to the second end 870 and is disposed between the first side 872 and the second side 874 and between the third and fourth recesses 887, 889. The lumen 886 is sized and configured to receive the elongate tubular member 720. The third recess 887 extends from the second side 874 toward the first side 872, is disposed between the first end 868 and the second end 870, and is sized and configured to house a weighted member of the plurality of weighted members 1102. The fourth recess 889 extends from the second side 874 toward the first side 872, is disposed between the first end 868 and the second end 870, and is sized and configured to house a weighted member of the plurality of weighted members 1102. In the illustrated embodiment, the bracket 804 is attached to the sidewall 734 using the first and second sealing members 806, 808 (e.g., the first and second sealing members 806, 808 compress to maintain the position of the bracket 804 within the lumen 824 defined by the sidewall 734).

The first sealing member 806 is disposed between the base 936 of the tip 718 and the bracket 804 and within the lumen 824 defined by the sidewall 734. The first sealing member 806 has a first end 890, a second end 892, and a main body 894 that defines a first recess 896, a second recess 898, a first lumen 900, a second lumen 902, a projection 904, a third recess 905, and a fourth recess 907. The first recess 896 extends from the first end 890 toward the second end 892 and is sized and configured to receive a portion of the PCBA 792. The second recess 898 extends from the second end 892 toward the first end 890 and is sized and configured to receive a portion of the tip 718. The first lumen 900 extends from the base 899 of the second recess 898 to the first end 890 and is in fluid communication with the passageway 754 defined by the tip 718 and the passageway 760 defined by the elongate tubular member 720. The second lumen 902 extends from the first end 890 to the second end 892 and is sized and configured to receive a portion of the light source 722. The projection 904 extends from the first end 890 and away from the second end 892 and is partially disposed within the first slot 882 defined by the bracket 804. The third recess 905 extends from the second end 892 toward the first end 890 and is sized and configured to receive a portion of the base 936 of the tip 718. The fourth recess 907 extends from the second end 892 toward the first end 890 and is sized and configured to receive a portion of the base 936 of the tip 718. The first sealing member 806 is formed of a compressible material (e.g., silicone) and contacts the bracket 804, the PCBA 792, the elongate tubular member 720, and the tip 718 such that each of these components can be maintained in its relative position.

The second sealing member 808 is disposed between the top wall 738 and the bracket 804, within the lumen 824 defined by the sidewall 734, and within the lumen 864 defined by the top wall 738. The second sealing member 808 has a first end 914, a second end 916, and a main body 918 that defines a lumen 920. The lumen 920 extends from the first end 914 to the second end 916 and is in fluid communication with the passageway 760 defined by the elongate tubular member 720. The lumen 920 has a first portion 922, a second portion 924, and a third portion 926. The first portion 922 extends from the second end 916 to the second portion 924. The second portion 924 extends from the first portion 922 to the third portion 926. The third portion 926 extends from the second portion 924 to the first end 914. The second sealing member 808 is formed of a compressible material (e.g., silicone) and contacts the bracket 804, the elongate tubular member 720, the top wall 738, and the mouthpiece 762 such that each of these components can be maintained in its relative position.

In the illustrated embodiment, the first chamber 744 is cooperatively defined by the bracket 804 and the sidewall 734, the second chamber 810 is cooperatively defined by the bracket 804 and the first sealing member 706, the third chamber 812 is cooperatively defined by the bracket 804, the first sealing member 806, and the second sealing member 808, the fourth chamber 813 is cooperatively defined by the bracket 804 and the side wall 734, and the fifth chamber 815 is cooperatively defined by the bracket 804 and the side wall 734. Each of the first chamber 744, the second chamber 810, the third chamber 812, the fourth chamber 813, and the fifth chamber 815 is disposed between the first end 730 and the second end 732 of the housing 712. The first chamber 744 is disposed between the first and second ends 868, 870 of the bracket 804. The second chamber 810 is disposed between the first chamber 744 and the first sealing member 806. The third chamber 812 extends through the entire length of the bracket 804 and from the first sealing member 806 to the second sealing member 808. The fourth chamber 813 is disposed between the first and second ends 868, 870 of the bracket 804. The fifth chamber 815 is disposed between the first and second ends 868, 870 of the bracket 804.

The power source 714 is disposed on the housing 712 and is electrically connected to the PCBA 792, the tip 718 via the PCBA 792, and the light source 722 via the PCBA 792. In the illustrated embodiment, the power source 714 is disposed within the first chamber 744 and a cushion 930 is disposed between the power source 714 and the sidewall 734. A cushion 930 is also disposed between each of the weighted members 1102 and the sidewall 734.

The first switch 716 is disposed on the housing 712 and is connected to the PCBA 792. In the embodiment shown, the first switch 716 is attached to the bracket 804, is disposed within the third opening 830 defined by the sidewall 734, and is accessible by a user. The first switch 716 has a first configuration and a second configuration and can be selectively activated by a user. The heating element 752 is in the off state when the first switch 716 is in the first configuration. The heating element 752 is in the on state when the first switch 716 is in the second configuration. In the illustrated embodiment, the first switch 716 comprises a push-button switch 750.

The tip 718 is disposed on the second end 732 of the housing 712. The tip 718 has a lengthwise axis 719, a first end 932, a second end 934, includes a heating element 752, a base 936, a threaded member 938, an insulating ring 940, an electrode 942, a first magnet 943, a second magnet 945, and defines a passageway 754 that extends from the first end 932 to the second end 934. The tip 718 is electrically connected to the power source 714 via the PCBA 792 and the electrode 942, is connected to the first switch 716, and is configured to heat a consumable product (e.g., oil, wax, concentrate, combustible plant substance) using the heating element 752 to create a vapor for a user to inhale.

The base 936 houses a portion of the threaded member 938, the insulating ring 940, the electrode 942, and each of the first and second magnets 943, 945. The base 936 has a first end 950, a second end 952, and a main body 953 that defines a first lumen 954, a second lumen 956, a first recess 957, a second recess 959, a third lumen 961, a fourth lumen 963. The first lumen 954 extends from the first end 950 to the second end 952. The first lumen 954 is in fluid communication with the lumen 948 defined by the heating element 752. The second lumen 956 is disposed adjacent to the first lumen 954 and is the passageway 748 defined by the housing 712 such that direct light from the light source 722 can pass through the second lumen 956 when the light source 722 is in the on state. The second lumen 956 has a center 847, a lengthwise axis 849, and is in fluid communication with the second chamber 810. The lengthwise axis 849 of the second lumen 956 extends through the second lumen 956, through the center 847, and is disposed parallel to the lengthwise axis 729 of the housing 712. In the illustrated embodiment, the lengthwise axis 849 extends through the second lumen 956, through the center 847, and is adjacent to the tip 718 such that the lengthwise axis 849 of the second lumen 956 does not intersect the tip 718. The first recess 957 extends from the second end 952 toward the first end 950 and houses the first magnet 943. The second recess 959 extends from the second end 952 toward the first end 950 and houses the second magnet 945.

The threaded member 938 is disposed between the heating element 752 and the first sealing member 806 and within the first lumen 954 defined by the base 936. The threaded member 938 has a first end 960, a second end 962, and a main body 964 that defines a lumen 966, a projection 968, and a thread 970. The insulating ring 940 is disposed within the lumen 964 defined by the threaded member 938 and within the recess 990 defined by the electrode 942. The insulating ring 940 has a tapered first end 972, a second end 974, and a main body 976 that defines a lumen 978 and a recess 980. The electrode 942 is disposed within the lumen 978 defined by the insulating ring 940 and has a first end 982, a second end 984, and a main body 986 that defines a lumen 988 and a recess 990. The recess 990 is disposed between the first end 982 and the second end 984 and is sized and configured to receive a portion of the insulating ring 940 to accomplish releasable attachment between the insulating ring 940 and the electrode 942.

The elongate tubular member 720 is disposed within the lumen 886 defined by the bracket 804 and is entirely disposed within the third chamber 812. The elongate tubular member 720 has a first end 756, a second end 758, and defines a passageway 760. The first end 756 contacts the second sealing member 808 such that the passageway 760 defined by the elongate tubular member 720 is in fluid communication with the lumen 920 defined by the second sealing member 808. The second end 758 contacts the first sealing member 806 such that the passageway 760 defined by the elongate tubular member 720 is in fluid communication with the first lumen 900 defined by the first sealing member 806.

The light source 722 has a lengthwise axis 763, a center 765, is disposed on the housing 712, and is moveable between an on state and an off state. The light source 722 is disposed between the first end 730 and the second end 732 of the housing 712, on the PCBA 792, and is electrically connected to the power source 714 via the PCBA 790 and is connected to the second switch 790 via the PCBA 792. The light source 722 can be moved between the off state and the on state by the power source 714 upon selective activation of the second switch 790 by a user. When activated, the light source 722 emits direct light away from the first end 730 of the housing 712. In the illustrated embodiment, when activated, the light source 722 emits light from the second end 732 of the housing 712 and through the passageway 748 of the housing 712, the second lumen 956 of the base 936 and direct light is directed parallel to, and towards, the tip 718 and strikes a location distal to the tip 718 and the tip 718. In the embodiment shown, when a user selectively activates the second switch 790 the light source 722 is activated.

The light source 722 is positioned adjacent the passageway 748 of the housing 712 such that the lengthwise axis 763 of the light source 722 extends through the light source 722, through passageway 748 of the housing 712, and is parallel the lengthwise axis 729 of the housing 712. In the illustrated embodiment, the light source 722 is partially disposed within the second lumen 902 of the first sealing member 806 such that the lengthwise axis 763 of the light source 722 extends through the light source 722, through passageway 748 of the housing 712, and is parallel to the lengthwise axis 719 of the tip 718 such that the lengthwise axis 763 of the light source 722 does not intersect the lengthwise axis of the tip 719.

As described herein, the housing 712 and the light source 722 have a specific relative structural arrangement to accomplish direct light being directed away from the first end 730 of the housing 712 and striking a location distal to the tip 718. In the illustrated embodiment, the lengthwise axis 747 of the passageway 748 (e.g., lengthwise axis 849) and the lengthwise axis 763 of the light source 722 are coaxial and parallel to the lengthwise axis 719 of the tip 718 and the lengthwise axis 729 of the housing 712.

The first cap 724 is disposed on the second end 732 of the housing 712 and has a first portion 770 and a second portion 772. The first cap 724 can be releasably attached to the housing 712 such that the first portion 770 is releasably attached to the housing 712. Alternatively, the cap 724 can be free of attachment to the housing 712 in which the first portion 770 is free of attachment to the housing 712 and is capable of releasable attachment to the housing 712. In the illustrated embodiment, the top wall 1004 is disposed within the passageway 1016 defined by the sidewall 1002 and includes structure for providing releasable attachment between the first cap 724 and the tip 718. The top wall 1004 has a first end 1005, a second end 1007, and a main body 1009 that defines a first lumen 1011, a first recess 1013, and a second recess 1015. The first lumen 1011 extends from the first end 1005 to the second end 1007 and is sized to receive a portion of the tip 718 when the first cap 724 is releasably attached to the housing 712. The first recess 1013 extends from the first end 1005 toward the second end 1007 and houses a first cap first magnet 1017. The second recess 1015 extends from the first end 1005 toward the second end 1007 and houses a first cap second magnet 1019. The first magnet 943 of the tip 718 is magnetically attracted to the first cap first magnet 1017 and the second magnet 945 of the tip 718 is magnetically attracted to the first cap second magnet 1019 such that releasable attachment between a first cap 724 and the housing 712 can be accomplished.

The weighted members 1102 are disposed within the third recess 887 of the bracket 804, which cooperatively defines the fourth chamber 813 with the sidewall 734, and the fourth recess 889 of the bracket 804, which cooperatively defined the fifth chamber 815 with the sidewall 734. Each of the weighted members 1102 provides a mechanism for providing a balanced vaporization device 710 for ease of use by a user and can be any suitable weighted member (e.g., piece of metal, piece of plastic).

While the components described herein and illustrated in the figures have been shown as having a particular structural arrangement, each component can have any suitable structural arrangement, be formed of any suitable material, and be manufactured using any suitable technique or method. Selection of a suitable structural arrangement for a component included in a vaporization device, material to form a component included in a vaporization device, and of a suitable technique or method of manufacture for a component included in a vaporization device can be based on various considerations, such as the type of consumable product intended to be used with the vaporization device. Examples of materials considered suitable to form a component included in a vaporization device include plastics, metals, aluminum alloys, and any other material considered suitable for a particular embodiment.

Those with ordinary skill in the art will appreciate that various modifications and alternatives for the described and illustrated examples can be developed in light of the overall teachings of the disclosure, and that the various elements and features of one example described and illustrated herein can be combined with various elements and features of another example without departing from the scope of the invention. Accordingly, the particular arrangement of elements and steps disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. A vaporization device for a consumable product, the vaporization device comprising:
a housing having a first end and a second end;
a power source disposed within the housing;
a tip disposed on the housing, the tip having a heating element connected to the power source and configured to heat said consumable product to create a vapor, the heating element moveable between an on state and off state;
a switch attached to the housing, the switch moving the heating element between the on state and the off state upon selective activation of the switch; and
a light source disposed on the housing and moveable between an on state and an off state, the light source emitting direct light away from the first end of the housing when the light source is in the on state.

2. The vaporization device of claim 1, wherein the housing has a lengthwise axis; and
wherein the light source emits direct light towards the lengthwise axis of the housing when the light source is in the on state.

3. The vaporization device of claim 2, wherein direct light from the light source strikes the tip when the light source is in the on state.

4. The vaporization device of claim 1, wherein the light source is disposed between the first end and the second end of the housing.

5. The vaporization device of claim 1, wherein the housing defines a passageway; and
wherein the light source emits light through the passageway of the housing.

6. The vaporization device of claim 5, wherein the light source is partially disposed within the passageway.

7. The vaporization device of claim 1, wherein the light source is disposed within the housing; and
wherein the light source is connected to the power source.

8. The vaporization device of claim 1, wherein the light source is an LED.

9. The vaporization device of claim 1, further comprising a cap disposed on the second end of the housing.

10. The vaporization device of claim 9, wherein the cap has a first portion releasably attached to the housing and a second portion releasably attached to the first portion.

11. The vaporization device of claim 10, wherein the first portion is formed of a first material and the second portion is formed of a second material that is different than the first material.

12. The vaporization device of claim 11, wherein the first portion is formed of an aluminum alloy; and
wherein the second portion is formed of a ceramic.

13. The vaporization device of claim 1, wherein the housing is formed of aluminum alloy; and
wherein the tip is formed of titanium.

14. The vaporization device of claim 1, further comprising a second switch attached to the housing; and
wherein the second switch moves the light source between the on state and the off state upon selective activation of the second switch.

15. The vaporization device of claim 1, wherein the tip defines a passageway; and
further comprising an elongate tubular member disposed within the housing and in fluid communication with the passageway defined by the tip.

16. The vaporization device of claim 15, wherein the elongate tubular member is formed of glass.

17. The vaporization device of claim 1, further comprising a PCBA disposed within the housing and electrically connected to the power source, the heating element, and the light source.

18. The vaporization device of claim 17, wherein the switch is connected to the PCBA to move the heating element between the on state and the off state.

19. A vaporization device for a consumable product, the vaporization device comprising:
a housing having a first end, a second end, and defining a passageway;
a power source disposed within the housing;
a tip disposed on the housing, the tip having a heating element connected to the power source and configured to heat said consumable product to create a vapor, the heating element moveable between an on state and an off state;
a first switch attached to the housing, the first switch moving the heating element between the on state and the off state upon selective activation of the switch;
a light source disposed within the housing and moveable between an on state and an off state, the light source emitting direct light through the passageway of the housing and away from the first end of the housing when the light source is in the on state; and
a second switch attached to the housing, the second switch moving the light source between the on state and the off state upon selective activation of the second switch.

20. A vaporization device for a consumable product, the vaporization device comprising:
a housing having a first end, a second end, and defining a passageway;
a power source disposed within the housing;
a tip disposed on the housing, the tip having a heating element connected to the power source and configured to heat said consumable product to create a vapor, the heating element moveable between an on state and an off state;
a first switch attached to the housing, the first switch moving the heating element between the on state and the off state upon selective activation of the switch;
a light source disposed within the housing, connected to the power source, and moveable between an on state and an off state, the light source emitting direct light through the passageway of the housing and away from the first end of the housing when the light source is in the on state;
a second switch attached to the housing, the second switch moving the light source between the on state and the off state upon selective activation of the second switch; and
a cap disposed on the second end of the housing, the cap having a first portion releasably attached to the housing and a second portion releasably attached to the first portion, the first portion formed of a first material and the second portion formed of a second material that is different than the first material.
